(19) United States
(12) Patent Application Publication
(10) Pub. No.: US 2026/0170627 A1
(43) Pub. Date: Jun. 18, 2026

(54) GAZE AND EXPOSURE BASED DYNAMIC RESOURCE VOTING

(71) Applicant: QUALCOMM Incorporated, San Diego, CA (US)

(72) Inventors: Abhijeet DEY, Bengaluru (IN); Milan JAUHARI, Lucknow (IN); Shridhar Prakash PATIL, Chikkodi (IN); Joby ABRAHAM, Bangalore (IN)

(21) Appl. No.: 18/984,781

(22) Filed: Dec. 17, 2024

(51) Int. Cl. G06T 5/92; G06T 5/50

(52) U.S. Cl. CPC G06T 5/92; G06T 5/50; G06T 2207/20208

(57) ABSTRACT

Systems and techniques are described for image processing. For example, a computing device can obtain, from one or more sensors, image data comprising a plurality of frames of a scene for an active-frame duration. The image data of each window of a plurality of windows being associated with a respective data rate. For example, the image data can be divided into the plurality of windows. The computing device can determine, based on the respective data rate of each window of the plurality of windows, a respective processing scaling factor for each window of the plurality of windows for processing the image data. The computing device can process the image data based on the respective processing scaling factor determined for each window.

### FIELD

The present disclosure generally relates to image processing. For example, aspects of the present disclosure relate to gaze and exposure based dynamic resource voting.

### BACKGROUND

The increasing versatility of digital camera products has allowed digital cameras to be integrated into a wide array of devices and has expanded their use to different applications. For example, phones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

For image processing, dynamic voting (e.g., dynamic resource voting (DRV)) can be employed to optimize the camera chipset, such as a system on a chip (SOC), power overhead incurred during operation of the camera. With conventional static clocking mechanisms, the image signal processor (ISP) and double data rate (DDR) memory have a clock rate at a fixed frequency to meet the use case instantaneous performance requirements, which can result in requiring a significant power overhead throughout the use case timeline. Dynamic voting (e.g., performed by a DRV engine) can dynamically increase (e.g., by controlling ISP and DDR voting) the ISP and DDR clock rate during a sensor readout duration of the use case timeline, and lower the ISP and DDR clock rate immediately after the sensor readout duration has completed (e.g., such that the clock rate is low during a large blanking interval, in the use case timeline, where no sensor readout is being performed). In adjusting the clock rate as such, the large power overhead requirement can be limited to only the sensor readout portions of the use case timeline (e.g., which is only a percentage of the use case timeline). As such, employing dynamic voting for image processing can be advantageous from a sensor power perspective.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems and techniques for image processing. In some aspects, an apparatus for image processing is provided. The apparatus includes at least one memory and at least one processor coupled to the at least one memory and configured to: obtain, from one or more sensors, image data including a plurality of frames of a scene for an active-frame duration, wherein the image data of each window of a plurality of windows being associated with a respective data rate; determine, based on the respective data rate of each window of the plurality of windows, a respective processing scaling factor for each window of the plurality of windows for processing the image data; and process the image data based on the respective processing scaling factor determined for each window.

In some aspects, a method is provided for image processing. The method includes: receiving, from one or more sensors, image data including a plurality of frames of a scene for an active-frame duration, wherein the image data of each window of a plurality of windows being associated with a respective data rate; determining, based on the respective data rate of each window of the plurality of windows, a respective processing scaling factor for each window of the plurality of windows for processing the image data; and processing the image data based on the respective processing scaling factor determined for each window.

In some aspects, a non-transitory computer-readable medium is provided having stored thereon instructions that, when executed by at least one processor, cause the at least one processor to: obtain, from one or more sensors, image data including a plurality of frames of a scene for an active-frame duration, wherein the image data of each window of a plurality of windows being associated with a respective data rate; determine, based on the respective data rate of each window of the plurality of windows, a respective processing scaling factor for each window of the plurality of windows for processing the image data; and process the image data based on the respective processing scaling factor determined for each window.

In some aspects, an apparatus for image processing is provided. The apparatus includes: means for receiving, from one or more sensors, image data including a plurality of frames of a scene for an active-frame duration, wherein the image data of each window of a plurality of windows being associated with a respective data rate; means for determining, based on the respective data rate of each window of the plurality of windows, a respective processing scaling factor for each window of the plurality of windows for processing the image data; and means for processing the image data based on the respective processing scaling factor determined for each window.

In some aspects, an apparatus for image processing is provided. The apparatus includes at least one memory and at least one processor coupled to the at least one memory and configured to: obtain, from one or more high dynamic range (HDR) sensors, image data including a plurality of frames of a scene for an active-frame duration, wherein each frame of the plurality of frames has a respective exposure time of a plurality of exposure times; determine, based on the respective exposure time of each frame of the plurality of frames, a respective exposure ratio for each exposure time of the plurality of exposure times; determine, based on the respective exposure ratio for each exposure time of the plurality of exposure times, a respective start time and a respective processing scaling factor for each window of a plurality of windows; send, at the respective start time of each window of the plurality of windows based on the respective processing scaling factor determined for each window of the plurality of windows, a respective command for adjusting a frequency and a bandwidth for processing the image data; and process the image data based on the frequency and the bandwidth for processing the image data.

In some aspects, a method is provided for image processing. The method includes: receiving, from one or more high dynamic range (HDR) sensors, image data including a plurality of frames of a scene for an active-frame duration, wherein each frame of the plurality of frames has a respective exposure time of a plurality of exposure times; determining, based on the respective exposure time of each frame of the plurality of frames, a respective exposure ratio for each exposure time of the plurality of exposure times; determining, based on the respective exposure ratio for each exposure time of the plurality of exposure times, a respective start time and a respective processing scaling factor for each window of a plurality of windows; sending, at the respective start time of each window of the plurality of windows based on the respective processing scaling factor determined for each window of the plurality of windows, a respective command for adjusting a frequency and a bandwidth for processing the image data; and processing the image data based on the frequency and the bandwidth for processing the image data.

In some aspects, a non-transitory computer-readable medium is provided having stored thereon instructions that, when executed by at least one processor, cause the at least one processor to: obtain, from one or more high dynamic range (HDR) sensors, image data including a plurality of frames of a scene for an active-frame duration, wherein each frame of the plurality of frames has a respective exposure time of a plurality of exposure times; determine, based on the respective exposure time of each frame of the plurality of frames, a respective exposure ratio for each exposure time of the plurality of exposure times; determine, based on the respective exposure ratio for each exposure time of the plurality of exposure times, a respective start time and a respective processing scaling factor for each window of a plurality of windows; send, at the respective start time of each window of the plurality of windows based on the respective processing scaling factor determined for each window of the plurality of windows, a respective command for adjusting a frequency and a bandwidth for processing the image data; and process the image data based on the frequency and the bandwidth for processing the image data.

In some aspects, an apparatus for image processing is provided. The apparatus includes: means for receiving, from one or more high dynamic range (HDR) sensors, image data including a plurality of frames of a scene for an active-frame duration, wherein each frame of the plurality of frames has a respective exposure time of a plurality of exposure times; means for determining, based on the respective exposure time of each frame of the plurality of frames, a respective exposure ratio for each exposure time of the plurality of exposure times; means for determining, based on the respective exposure ratio for each exposure time of the plurality of exposure times, a respective start time and a respective processing scaling factor for each window of a plurality of windows; means for sending, at the respective start time of each window of the plurality of windows based on the respective processing scaling factor determined for each window of the plurality of windows, a respective command for adjusting a frequency and a bandwidth for processing the image data; and means for process the image data based on the frequency and the bandwidth for processing the image data.

In some aspects, an apparatus for image processing is provided. The apparatus includes at least one memory and at least one processor coupled to the at least one memory and configured to: obtain, from one or more foveated sensors, image data including a plurality of frames of a scene for an active-frame duration, wherein each frame of the plurality of frames has a respective region of a plurality of regions including a fovea region, a middle region, and a peripheral region; determine, based on motion tracking of a user associated with the one or more foveated sensors, an eye gaze location associated with the scene; determine, based on the eye gaze location associated with the scene, a location of the fovea region and a location of the middle region within the scene; determine, based on the location of the fovea region and the location of the middle region within the scene, a respective start time and a respective processing scaling factor for each window of a plurality of windows; send, at the respective start time of each window of the plurality of windows based on the respective processing scaling factor determined for each window of the plurality of windows, a respective command for adjusting a frequency and a bandwidth for processing the image data; and process the image data based on the frequency and the bandwidth for processing the image data.

In some aspects, a method is provided for image processing. The method includes: receiving, from one or more foveated sensors, image data including a plurality of frames of a scene for an active-frame duration, wherein each frame of the plurality of frames has a respective region of a plurality of regions including a fovea region, a middle region, and a peripheral region; determining, based on motion tracking of a user associated with the one or more foveated sensors, an eye gaze location associated with the scene; determining, based on the eye gaze location associated with the scene, a location of the fovea region and a location of the middle region within the scene; determining, based on the location of the fovea region and the location of the middle region within the scene, a respective start time and a respective processing scaling factor for each window of a plurality of windows; sending, at the respective start time of each window of the plurality of windows based on the respective processing scaling factor determined for each window of the plurality of windows, a respective command for adjusting a frequency and a bandwidth for processing the image data; and processing the image data based on the frequency and the bandwidth for processing the image data.

In some aspects, a non-transitory computer-readable medium is provided having stored thereon instructions that, when executed by at least one processor, cause the at least one processor to: obtain, from one or more foveated sensors, image data including a plurality of frames of a scene for an active-frame duration, wherein each frame of the plurality of frames has a respective region of a plurality of regions including a fovea region, a middle region, and a peripheral region; determine, based on motion tracking of a user associated with the one or more foveated sensors, an eye gaze location associated with the scene; determine, based on the eye gaze location associated with the scene, a location of the fovea region and a location of the middle region within the scene; determine, based on the location of the fovea region and the location of the middle region within the scene, a respective start time and a respective processing scaling factor for each window of a plurality of windows; send, at the respective start time of each window of the plurality of windows based on the respective processing scaling factor determined for each window of the plurality of windows, a respective command for adjusting a frequency and a bandwidth for processing the image data; and process the image data based on the frequency and the bandwidth for processing the image data.

In some aspects, an apparatus for image processing is provided. The apparatus includes: means for receiving, from one or more foveated sensors, image data including a plurality of frames of a scene for an active-frame duration, wherein each frame of the plurality of frames has a respective region of a plurality of regions including a fovea region, a middle region, and a peripheral region; means for determining, based on motion tracking of a user associated with the one or more foveated sensors, an eye gaze location associated with the scene; means for determining, based on the eye gaze location associated with the scene, a location of the fovea region and a location of the middle region within the scene; means for determining, based on the location of the fovea region and the location of the middle region within the scene, a respective start time and a respective processing scaling factor for each window of a plurality of windows; means for sending, at the respective start time of each window of the plurality of windows based on the respective processing scaling factor determined for each window of the plurality of windows, a respective command for adjusting a frequency and a bandwidth for processing the image data; and means for processing the image data based on the frequency and the bandwidth for processing the image data.

In some aspects, each of the apparatuses described above is, can be part of, or can include a mobile device (e.g., a mobile phone), a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some aspects of the disclosure.

FIG. 2 is a block diagram illustrating an example of interactions between components of an image capture and processing system, in accordance with some aspects of the disclosure.

FIG. 3 is a block diagram of an example device that may be used for camera dynamic voting, in accordance with some aspects of the disclosure.

FIG. 4 is a block diagram showing the operation of an image signal processor pipeline, in accordance with some aspects of the disclosure.

FIG. 5 is a diagram illustrating an example of timing for a camera using dynamic resource voting (DRV), in accordance with some aspects of the disclosure.

FIG. 6 is a diagram illustrating examples of image frames with different exposure times captured by a staggered high dynamic range (SHDR) sensor, in accordance with some aspects of the disclosure.

FIG. 7 is a diagram illustrating an example of an exposure and readout pattern of sensor data captured by a Bayer sensor, in accordance with some aspects of the disclosure.

FIG. 8 is a diagram illustrating an example of an exposure and readout pattern of sensor data captured by an SHDR sensor, in accordance with some aspects of the disclosure.

FIG. 9 is a diagram illustrating an example of a readout pattern of sensor data captured by an SHDR sensor with corresponding constant frequency and bandwidth settings for processing the sensor data, where the settings are generated based on dynamic resource voting, in accordance with some aspects of the disclosure.

FIG. 10 is a diagram illustrating an example of a readout pattern of sensor data captured by an SHDR sensor with corresponding varying frequency and bandwidth settings for processing the sensor data, where the settings are generated based on exposure-based dynamic resource voting, in accordance with some aspects of the disclosure.

FIG. 11 is a table illustrating examples of frequency and bandwidth settings for processing sensor data captured by an SHDR sensor, where the settings are generated based on existing dynamic resource voting and exposure-based dynamic resource voting, in accordance with some aspects of the disclosure.

FIG. 12 is a diagram illustrating examples of frequency settings for processing sensor data captured by an SHDR sensor, where the settings are generated based on existing dynamic resource voting and exposure-based dynamic resource voting, in accordance with some aspects of the disclosure.

FIG. 13 is a table illustrating examples of events to indicate markers for windows of a readout of sensor data captured by an SHDR sensor, in accordance with some aspects of the disclosure.

FIG. 14 is a diagram illustrating examples of windows of a readout of sensor data captured by an SHDR sensor, in accordance with some aspects of the disclosure.

FIG. 15 is a diagram illustrating an example of a system for exposure-based dynamic resource voting, in accordance with some aspects of the disclosure.

FIG. 16 is a diagram illustrating examples of different regions with different resolutions captured of a scene by a foveated sensor, in accordance with some aspects of the disclosure.

FIG. 17 is a diagram illustrating an example of a readout pattern of sensor data captured by a foveated sensor, in accordance with some aspects of the disclosure.

FIG. 18 is a diagram illustrating an example of a readout pattern of sensor data captured by a foveated sensor with corresponding constant frequency and bandwidth settings for processing the sensor data, where the settings are generated based on dynamic resource voting, in accordance with some aspects of the disclosure.

FIG. 19 is a diagram illustrating an example of a readout pattern of sensor data captured by a foveated sensor with corresponding varying frequency and bandwidth settings for processing the sensor data, where the settings are generated based on gaze-based dynamic resource voting, in accordance with some aspects of the disclosure.

FIG. 20 is a table illustrating examples of events to indicate markers for windows of a readout of sensor data captured by a foveated sensor, in accordance with some aspects of the disclosure.

FIG. 21 is a diagram illustrating examples of windows of a readout of sensor data captured by a foveated sensor, in accordance with some aspects of the disclosure.

FIG. 22 is a diagram illustrating an example of a system for gaze-based dynamic resource voting, in accordance with some aspects of the disclosure.

FIG. 23 is a flow diagram illustrating an example of a process for exposure and gaze based dynamic resource voting, in accordance with some aspects of the disclosure.

FIG. 24 is a flow diagram illustrating an example of a process for exposure-based dynamic resource voting, in accordance with some aspects of the disclosure.

FIG. 25 is a flow diagram illustrating an example of a process for gaze-based dynamic resource voting, in accordance with some aspects of the disclosure.

FIG. 26 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, for image processing, dynamic voting (e.g., dynamic resource voting (DRV)) can be employed to optimize the camera chipset, such as a system on a chip (SOC), power overhead incurred during operation of the camera. With conventional static clocking mechanisms, the image signal processor (ISP) and double data rate (DDR) memory have a clock rate at a fixed frequency to meet the use case instantaneous performance requirements, which can result in requiring a significant power overhead throughout the use case timeline. Dynamic voting (e.g., performed by a DRV engine) can dynamically increase (e.g., by controlling ISP and DDR voting) the ISP and DDR clock rate during a sensor readout duration of the use case timeline, and lower the ISP and DDR clock rate immediately after the sensor readout duration has completed (e.g., such that the clock rate is low during a large blanking interval, in the use case timeline, where no sensor readout is being performed). The dynamic voting can be based on detection of interframe idleness. In adjusting the clock rate as such, the large power overhead requirement can be limited to only the sensor readout portions of the use case timeline (e.g., which is only a percentage of the use case timeline). Therefore, employing dynamic voting for image processing can allow for a reduction in the chipset power overhead and, thus, be advantageous from a sensor power perspective.

Currently, existing DRV schemes work well with Bayer sensors (e.g., a type of camera sensors) where the sensor data rate is constant through an active-frame duration (e.g., a use case timeline). However, other types of camera sensors, such as staggered high dynamic range (SHDR) sensors and foveated sensors, have varying (e.g., non-constant) sensor data rates during the active-frame duration. For these other types of camera sensors (e.g., SHDR sensors and foveated sensors), the existing DRV schemes are unable to scale down the processing (e.g., the ISP and DDR clock rate) during periods of a low sensor data rate to allow for a conservation of the sensor power.

As such, improved systems and techniques for a DRV scheme that allow for a scaling down in processing (e.g., the ISP and DDR clock rate) during periods of a low sensor data rate can be beneficial.

In some aspects of the present disclosure, systems, apparatuses, methods (also referred to as processes), and computer-readable media (collectively referred to herein as “systems and techniques”) are described herein for gaze and exposure based dynamic resource voting.

Various aspects relate generally to image processing. Some aspects more specifically relate to systems and techniques that provide solutions that conserve intraframe ISP and SOC power for sensors (e.g., SHDR sensors and foveated sensors), where the sensor data rate varies within the active-frame duration. Existing DRV schemes cannot dynamically vote based on intraframe activity. In one or more examples, the systems and techniques provide an intraframe DRV scheme that generates dynamic intraframe votes for different windows of a sensor readout (e.g., a SHDR sensor readout or a foveated sensor readout) of an active-frame duration, where the votes are generated based on the data rate of respective windows of the active-frame duration. In some examples, the systems and techniques provide a hardware-based scheme, where based on an exposure ratio (or based on locations of regions of a scene of the active-frame duration), an intraframe DRV control can determine (e.g., compute) a start and end of each window, and can accordingly send a command (e.g., a vote up or vote down signal) for an ISP and DDR memory to modulate the clock frequency of the ISP and DDR clocks.

In one or more examples, during operation of the systems and techniques for image processing, one or more sensors can receive image data including a plurality of frames of a scene for one active-frame duration, wherein the image data is divided into a plurality of windows, each window of the plurality of windows being associated with a respective data rate. One or more processors can determine, based on the respective data rate of each window of the plurality of windows, a respective processing scaling factor for each window of the plurality of windows for processing the image data. The one or more processors can process, based on the respective processing scaling factor determined for each window, the image data.

In one or more examples, each sensor of the one or more sensors can be a high dynamic range (HDR) sensor. In some examples, the HDR sensor can be a staggered high dynamic range (SHDR) sensor. In one or more examples, each frame of the plurality of frames can be captured using a respective exposure time of a plurality of exposure times. In some examples, one or more processors (e.g., of an auto-exposure statistics engine) can determine, based on the image data, the respective exposure time for each frame of the plurality of frames. In one or more examples, one or more processors (e.g., of an exposure control engine) can determine, based on the respective exposure time determined for each frame of the plurality of frames, a respective exposure ratio for each exposure time of the plurality of exposure times. In some examples, the respective data rate of a window of the plurality of windows can be dependent upon the respective exposure ratio determined for an exposure time of one or more frames associated with the window. In one or more examples, one or more processors (e.g., of an intraframe DRV control engine) can determine, based on the respective exposure ratio determined for each exposure time of the plurality of exposure times, a respective start time and the respective processing scaling factor determined for each window of the plurality of windows. In some examples, one or more processors (e.g., of the intraframe DRV control engine) can send, at the respective start time of each window of the plurality of windows based on the respective processing scaling factor determined for each window of the plurality of windows, a respective command for adjusting a frequency and a bandwidth for processing the image data. In one or more examples, the respective command can be a positive voting result (e.g., a vote up) or a negative voting result (e.g., a vote down).

In one or more examples, each sensor of the one or more sensors can be a foveated sensor. In some examples, each frame of the plurality of frames can have a respective region of a plurality of regions of the scene, the plurality of regions including a fovea region having a first resolution, a middle region having a second resolution, and a peripheral region having a third resolution, wherein the second resolution is lower than the first resolution and higher than the third resolution. In one or more examples, one or more processors (e.g., of an eye, head, and motion tracking engine) can determine, based on motion tracking of a user associated with the one or more sensors, an eye gaze location associated with the scene. In some examples, one or more processors (e.g., of an eye gaze prediction engine) can determine, based on the eye gaze location associated with the scene, a location of the fovea region and a location of the middle region within the scene. In one or more examples, the respective data rate of each window of the plurality of windows can be dependent upon the respective region of each of the frames associated with the window and in some cases based on a resolution of each region. In some examples, one or more processors (e.g., of an intraframe DRV control engine) can determine, based on a location of the fovea region and a location of the middle region within the scene, a respective start time and the respective processing scaling factor for each window of the plurality of windows (e.g., dependent on the resolution of each region). In one or more examples, one or more processors (e.g., of the intraframe DRV control engine) can send, at the respective start time of each window of the plurality of windows based on the respective processing scaling factor for each window of the plurality of windows, a respective command for adjusting a frequency and a bandwidth for processing the image data. In some examples, the respective command is a positive voting result or a negative voting result.

In one or more examples, during operation of the systems and techniques for image processing, one or more high dynamic range (HDR) sensors can receive image data including a plurality of frames of a scene for one active-frame duration, wherein the image data is divided into a plurality of windows, and wherein each frame of the plurality of frames has a respective exposure time of a plurality of exposure times. One or more processors (e.g., of an exposure control engine) can determine, based on the respective exposure time of each frame of the plurality of frames, a respective exposure ratio for each exposure time of the plurality of exposure times. One or more processors (e.g., of an intraframe DRV control engine) can determine, based on the respective exposure ratio for each exposure time of the plurality of exposure times, a respective start time and a respective processing scaling factor for each window of the plurality of windows. One or more processors (e.g., of the intraframe DRV control engine) can send, at the respective start time of each window of the plurality of windows based on the respective processing scaling factor determined for each window of the plurality of windows, a respective command for adjusting a frequency and a bandwidth for processing the image data. One or more processors can process, based on the frequency and the bandwidth for processing the image data, the image data. In one or more examples, the one or more HDR sensors can include one or more staggered high dynamic range (SHDR) sensors.

In one or more examples, during operation of the systems and techniques for image processing, one or more foveated sensors can receive image data including a plurality of frames of a scene for one active-frame duration, wherein the image data is divided into a plurality of windows, and wherein each frame of the plurality of frames has a respective region of a plurality of regions including a fovea region, a middle region, and a peripheral region. One or more processors (e.g., of an eye, head, and motion tracking engine) can determine, based on motion tracking of a user associated with the one or more foveated sensors, an eye gaze location associated with the scene. One or more processors (e.g., of an eye gaze prediction engine) can determine, based on the eye gaze location associated with the scene, a location of the fovea region and a location of the middle region within the scene. One or more processors (e.g., of an intraframe DRV control engine) can determine, based on the location of the fovea region and the location of the middle region within the scene, a respective start time and a respective processing scaling factor for each window of the plurality of windows. One or more processors, (e.g., of the intraframe DRV control engine) can send, at the respective start time of each window of the plurality of windows based on the respective processing scaling factor determined for each window of the plurality of windows, a respective command for adjusting a frequency and a bandwidth for processing the image data. One or more processors can process, based on the frequency and the bandwidth for processing the image data, the image data.

Particular aspects of the subject matter described in this disclosure can be implemented to realize one or more of the following potential advantages. In one or more examples, the systems and techniques have the benefit of providing an intraframe DRV mechanism to save significant power in ISP, SOC, and DDR memory for SHDR sensors (e.g., which are prevalent in mobile and computing devices) and foveated sensors (e.g., which are primarily used in VR devices, such as for video see through (VST) use cases). In some examples, the systems and techniques have the benefit of providing a DRV scheme that is robust and adaptive to changes in the exposure ratio of SHDR sensors and changes in an eye gaze of a user associated with foveated sensors. In one or more examples, the systems and techniques have the benefit of providing a DRV scheme that is generic and can be scaled for any number of different exposure times (e.g., transmitted from SHDR sensors) and any number of different regions (e.g., transmitted from foveated sensors). In some examples, the systems and techniques have the benefit of allowing for a seamless integration into current, existing, DRV solutions, which detect interframe idleness. In one or more examples, the systems and techniques have the benefit of providing a universal power saving mechanism, which can work for all different types of sensors and all different types of use cases, which may be both interframe and intraframe. In some examples, the systems and techniques have the benefit of providing a high power savings, while incurring only a negligible SOC area cost.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

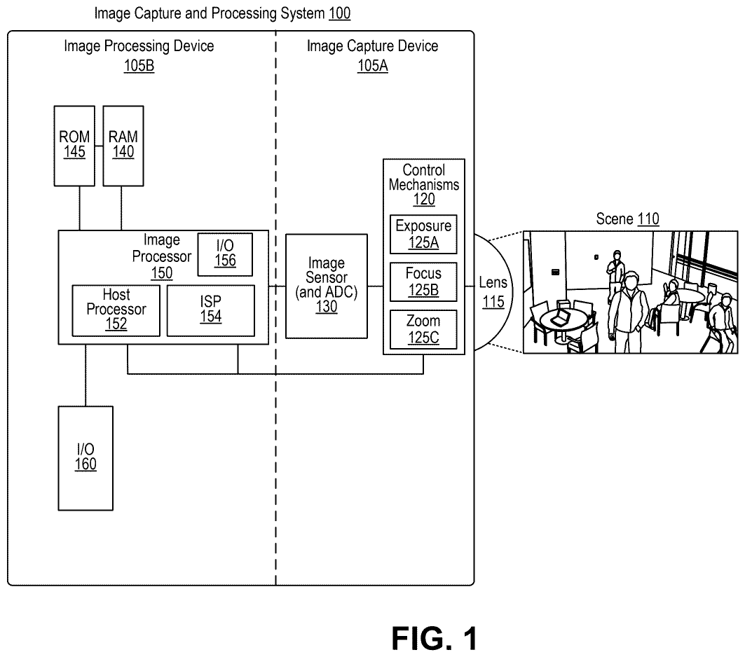

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 2610 discussed with respect to the computing system 2600. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), neural processing units (NPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface), an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/2625, read-only memory (ROM) 145/2620, a cache 2612, a memory unit 2615, another storage device 2630, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 2635, any other input devices 2645, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

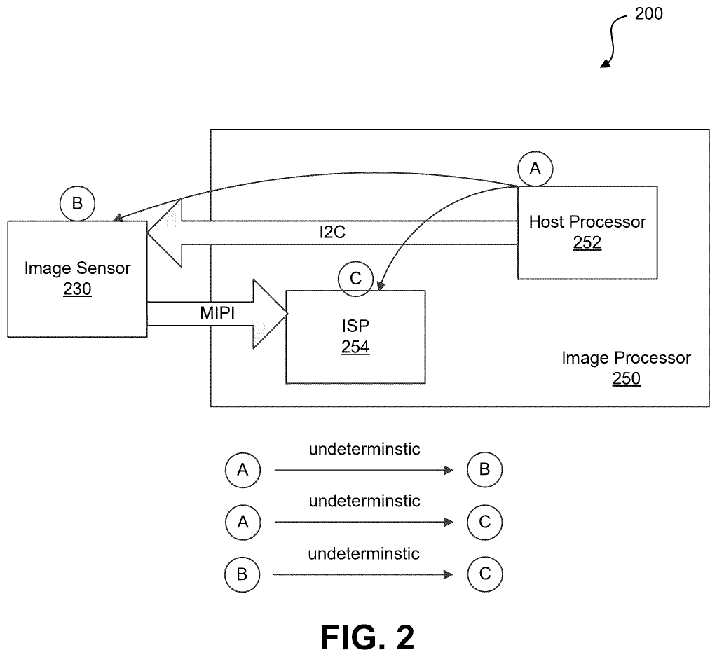

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

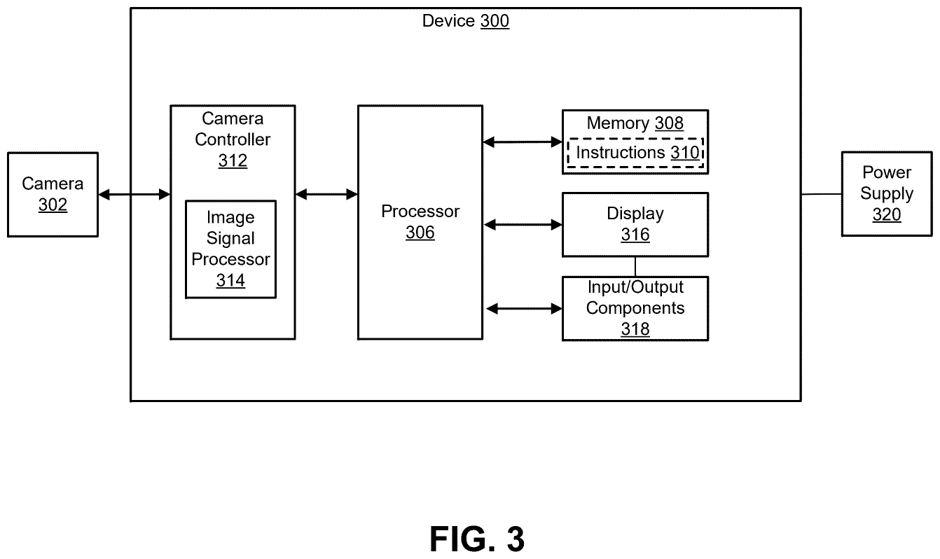

FIG. 3 is a block diagram of an example device 300 that may be used for camera dynamic voting. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

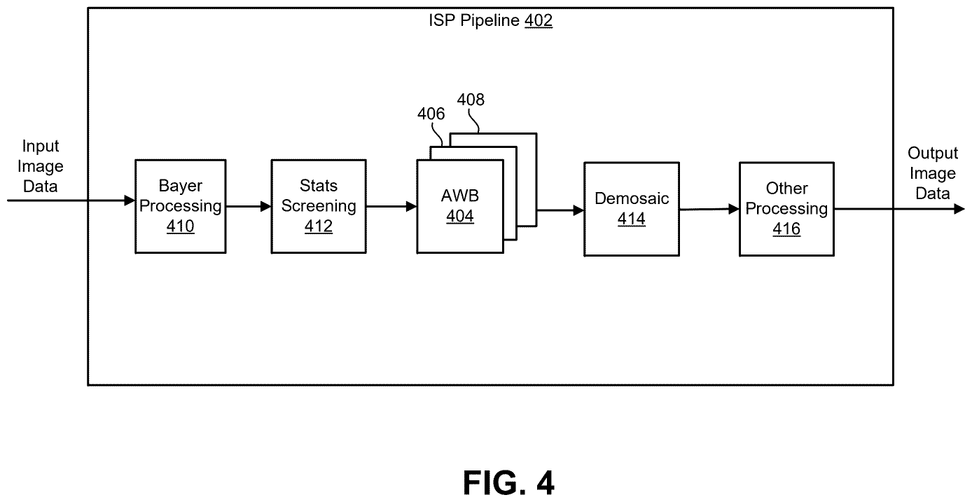

FIG. 4 is a block diagram showing the operation of an image signal processing pipeline 402 of an image signal processor (e.g., the ISP 314). For example, the ISP 314 may be configured to execute the image signal processing pipeline 402 to process input image data. The ISP 314 may receive the input image data from camera 302 of FIG. 3 and/or an image sensor (not shown) of camera 302. In some examples, such as shown in FIG. 4, the input image data may include color data of the image/frame and/or any other data (e.g., depth data). In the example of FIG. 4, the color data received for the input image data may be in a Bayer format. Rather than capturing red (R), green (G), and blue (B) values for each pixel of an image, image sensors (e.g., an image sensor of camera 302) may use a Bayer filter mosaic (or more generally, a color filter array (CFA)), where each photosensor of a digital image sensor captures a different one of the RGB colors. One example of a filter pattern for a Bayer filter mosaic may include 50% green filters, 25% red filters, and 25% blue filters.

Bayer processing unit 410 may perform one or more initial processing techniques on the raw Bayer data received by ISP 314, including, for example, subtraction, rolloff correction, bad pixel correction, black level compensation, and/or denoising.

Stats screening process 412 may determine Bayer grade or Bayer grid (BG) statistics of the received input image data. In some examples, BG statistics may include a red color to green color ratio (R/G) (which may indicate whether a red tinting exists and the magnitude of the red tinting that may exist in an image) and/or a blue color to green color ratio (B/G) (which may indicate whether a blue tinting exists and the magnitude of the blue tinting that may exist in an image). For example, the (R/G) for an image or a portion/region of an image may be depicted by equation (1) below:

$$R / G = \frac{{\sum }_{n = 1}^{N} Red ( n )}{{\sum }_{n = 1}^{N} Green ( n )} \qquad ( 1 )$$

where the image or a portion/region of the image includes pixels 1−N, each pixel n includes a red value Red (n), a blue value Blue (n), or a green value Green (n) in an RGB space. The (R/G) is the sum of the red values for the red pixels in the image divided by the sum of the green values for the green pixels in the image. Similarly, the (B/G) for the image or a portion/region of the image may be depicted by equation (2) below:

$$B / G = \frac{{\sum }_{n = 1}^{N} Blue ( n )}{{\sum }_{n = 1}^{N} Green ( n )} \qquad ( 2 )$$

In some other example implementations, a different color space may be used, such as Y′UV, with chrominance values UV indicating the color, and/or other indications of a tinting or other color temperature effect for an image may be determined.

AWB module and/or process 404 may analyze information relating to the received image data to determine an illuminant of the scene, from among a plurality of possible illuminants, and may determine an AWB gain to apply to the received image and/or a subsequent image based on the determined illuminant. White balance is a process used to try to match colors of an image with a user's perceptual experience of the object being captured. As an example, the white balance process may be designed to make white objects actually appear white in the processed image and gray objects actually appear gray in the processed image.

An illuminant may include a lighting condition, a type of light, etc. of the scene being captured. In some examples, a user of an image capture device (e.g., such as device 300 of FIG. 3) may select or indicate an illuminant under which an image was captured. In other examples, the image capture device itself may automatically determine the most likely illuminant and perform white balancing based on the determined illuminant (e.g., lighting condition). In order to better render the colors of a scene in a captured image or video, an AWB algorithm on a device and/or camera may attempt to determine the illuminants of the scene and set/adjust the white balance of the image or video accordingly.

Device 300, during the AWB process 404, may determine or estimate a color temperature for a received frame (e.g., image). The color temperature may indicate a dominant color tone for the image. The true color temperature for a scene being captured in a video or image is the color of the light sources for the scene. If the light is radiation emitted from a perfect blackbody radiator (theoretically ideal for all electromagnetic wavelengths) at a particular color temperature (represented in Kelvin (K)), and the color temperatures are known, then the color temperature for the scene is known. For example, in a Commission Internationale de l′éclairage (CIE) defined color space (from 1931), the chromaticity of radiation from a blackbody radiator with temperatures from 1,000 to 20,000 K is the Planckian locus. Colors on the Planckian locus from approximately 2,000 K to 20,000 K are considered white, with 2,000 K being a warm or reddish white and 20,000 K being a cool or bluish white. Many incandescent light sources include a Planckian radiator (tungsten wire or another filament to glow) that emits a warm white light with a color temperature of approximately 2,400 to 3,100 K.

However, other light sources, such as fluorescent lights, discharge lamps, or light emitting diodes (LEDs), are not perfect blackbody radiators whose radiation falls along the Planckian locus. For example, an LED or a neon sign emit light through electroluminescence, and the color of the light does not follow the Planckian locus. The color temperature determined for such light sources may be a correlated color temperature (CCT). The CCT is the estimated color temperature for light sources whose colors do not fall exactly on the Planckian locus. For example, the CCT of a light source is the blackbody color temperature that is closest to the radiation of the light source. CCT may also be denoted in K.

CCT may be an approximation of the true color temperature for the scene. For example, the CCT may be a simplified color metric of chromaticity coordinates in the CIE 1931 color space. Many devices may use AWB to estimate a CCT for color balancing.

The CCT may be a temperature rating from warm colors (such as yellows and reds below 3200 K) to cool colors (such as blue above 4000 K). The CCT (or other color temperature) may indicate the tinting that will appear in an image captured using such light sources. For example, a CCT of 2700 K may indicate a red tinting, and a CCT of 5000 K may indicate a blue tinting.

Different lighting sources or ambient lighting may illuminate a scene, and the color temperatures may be unknown to the device. As a result, the device may analyze data captured by the image sensor to estimate a color temperature for an image (e.g., a frame). For example, the color temperature may be an estimation of the overall CCT of the light sources for the scene in the image. The data captured by the image sensor used to estimate the color temperature for a frame (e.g., image) may be the captured image itself.

After device 300 determines a color temperature for the scene (such as during performance of AWB), device 300 may use the color temperature to determine a color balance for correcting any tinting in the image. For example, if the color temperature indicates that an image includes a red tinting, device 300 may decrease the red value or increase the blue value for each pixel of the image, e.g., in an RGB space. The color balance may be the color correction (such as the values to reduce the red values or increase the blue values).

Example inputs to AWB process 404 may include the Bayer grade or Bayer grid (BG) statistics of the received image data determined via stats screening process 412, an exposure index (e.g., the brightness of the scene of the received image data), and auxiliary information, which may include the contextual information of the scene based on the audio input (as will be discussed in further detail below), depth information, etc. It should be noted that AWB process 404 may be included within camera controller 312 of FIG. 3 as a separate AWB module.

AE process 406 may include instructions for configuring, calculating, and/or storing an exposure setting of camera 302 of FIG. 3. An exposure setting may include an amount of sensor gain to be applied, an amount of digital gain to be applied, shutter speed and/or exposure time, an aperture setting, and/or an ISO setting to use to capture subsequent images. AE process 406 may use the audio input and/or the contextual information of the scene based on the audio input to determine and/or apply exposure settings faster. It should be noted that AE process 406 may be included within camera controller 312 of FIG. 3 as a separate AE module.

AF process 408 may include instructions for configuring, calculating and/or storing an auto focus setting of camera 302 of FIG. 3. AF process 408 may determine the auto focus setting (e.g., an initial lens position, a final lens position, etc.) based on the audio input and/or the contextual information of the scene based on the audio input. It should be noted that AF process 408 may be included within camera controller 312 of FIG. 3 as a separate AF module.

Demosaic processing unit 414 may be configured to convert the processed Bayer image data into RGB values for each pixel of an image. As explained above, Bayer data may only include values for one color channel (R, G, or B) for each pixel of the image. Demosaic processing unit 414 may determine values for the other color channels of a pixel by interpolating from color channel values of nearby pixels. In some ISP pipelines 402, demosaic processing unit 414 may come before AWB, AE, and/or AF processes 404, 406, 408 or after AWB, AE, and/or AF processes 404, 406, 408.

Other processing unit 416 may apply additional processing to the image after AWB, AE, and/or AF processes 404, 406, 408 and/or demosaic processing unit 414. The additional processing may include color, tone, and/or spatial processing of the image.

As previously mentioned, for image processing, dynamic voting (e.g., dynamic resource voting (DRV)) may be utilized to optimize the camera chipset (e.g., an SOC) power overhead incurred during operation of the camera. With conventional static clocking mechanisms, the ISP and DDR memory have a clock rate at a fixed frequency to meet the use case instantaneous performance requirements, which can require a significant power overhead throughout the use case timeline. Dynamic voting (e.g., performed by a DRV engine) can dynamically increase (e.g., by controlling ISP and DDR voting) the ISP and DDR clock rate during a sensor readout duration of the use case timeline, and lower the ISP and DDR clock rate immediately after the sensor readout duration has completed (e.g., such that the clock rate is low during a large blanking interval, in the use case timeline, where no sensor readout is being performed). The dynamic voting may be based on detection of interframe idleness. When adjusting the clock rate as such, the large power overhead requirement may be limited to only the sensor readout portions of the use case timeline (e.g., which is only a portion of the use case timeline). As such, employing dynamic voting for image processing may allow for a reduced chipset power overhead, which can be advantageous from a sensor power perspective.

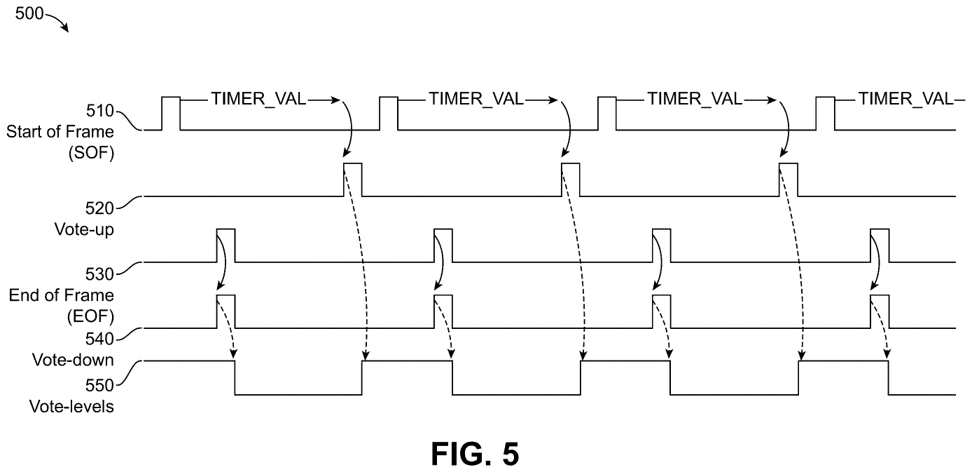

FIG. 5 is a diagram illustrating an example of timing for a camera using DRV. In FIG. 5, start of frame (SOF) timing 510, vote up timing 520, end of frame (EOF) timing 530, vote down timing 540, and vote levels timing 550 are shown.

The DRV can be used to reduce the SOC power by controlling the ISP (e.g., an image front end (IFE) component referring to a component of the ISP that receives image sensor data direction from an image sensor) and DDR vote. SW can configure a DRV timer (e.g., TIMER_VAL in SOF timing 510) at the beginning of each use case. The timer (e.g., TIMER_VAL) can start counting at each SOF (e.g., each SOF is denoted by each pulse of the SOF timing 510). When the timer (e.g., TIMER_VAL) expires, there is a vote up (e.g., each vote up is denoted by each pulse of the vote up timing 520) of the IFE and DDR resources, such that the IFE and DDR resources are ready to receive the next SOF.

The vote levels (e.g., as shown in the vote levels timing 550) of the resources will go up and down, based on the vote ups (e.g., pulses) in the vote up timing 520 and the vote downs (e.g., pulses) in the vote down timing 540. As such, when the timer (e.g., TIMER_VAL) expires, the vote level of the vote levels timing 550 goes up. As such, when the next SOF arrives in the SOF timing 510, the IFE and DDR resources are ready to accept the data.

When an EOF (e.g., each EOF is denoted by each pulse of the EOF timing 530) is received, there is a corresponding vote down (e.g., each vote down is denoted by each pulse of the vote down timing 540) of the IFE and DDR resources to conserve power. When there is a vote down in the vote down timing 540, the vote level of the vote levels timing 550 will go down.

In summary, the vote level of the vote levels timing 550 goes up when the timer (e.g., TIMER_VAL) of the SOF timing 510 expires. When an EOF in the EOF timing 530 occurs, there is a corresponding vote down in the vote down timing 540 (e.g., to save IFE and DDR power) and, as such, the vote level of the vote level timing 550 goes down, and this cycle keeps repeating.

In existing DRV schemes, voting is SOF timer and EOF based. These existing DRV schemes only detect interframe idleness to dynamically scale the ISP (e.g., IFE) clock and DDR bandwidth (BW). Existing DRV schemes work well with Bayer sensors, where the sensor data rate is constant through an active-frame duration (e.g., which may be defined as an active frame window). However, other types of camera sensors, such as SHDR sensors and foveated sensors, have varying (e.g., non-constant) sensor data rates during the active-frame duration. For these other types of camera sensors (e.g., SHDR sensors and foveated sensors), the existing DRV schemes are unable to scale down (e.g., vote down) the processing (e.g., the ISP and DDR clock rate) during periods of a low sensor data rate to allow for a savings in the sensor power.

In one or more aspects, SHDR sensors are prominent in mobile and computing device platforms. SHDR sensors capture separate image frames based on long, medium, and short exposure times (e.g., which may be simply referred to as exposures).

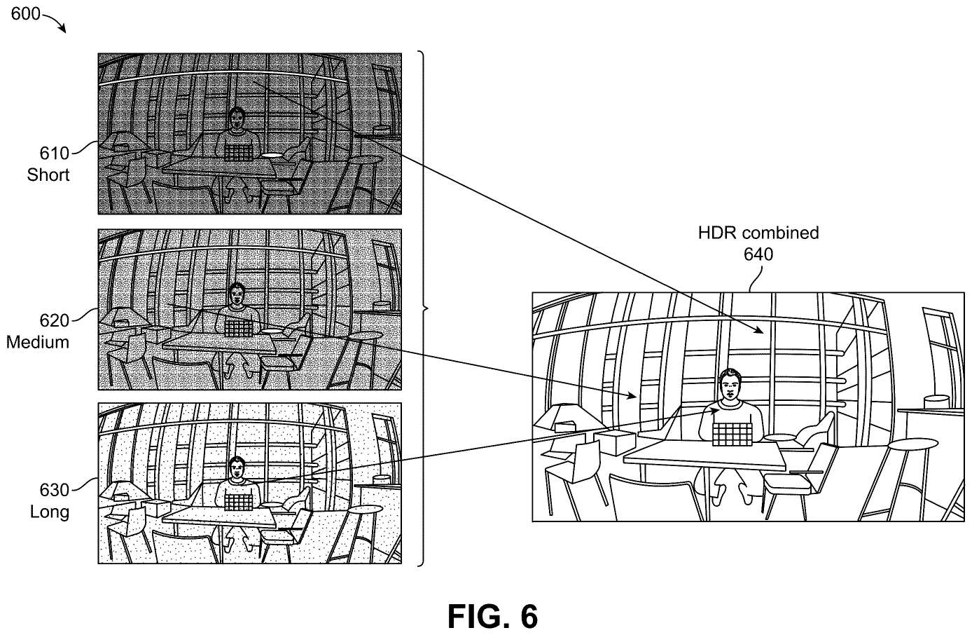

FIG. 6 shows example image frames of a scene captured with an SHDR sensor with three different exposure times. In particular, FIG. 6 is a diagram illustrating examples 600 of image frames 610, 620, 630 with different exposure times (e.g., short, medium, and long) captured by an SHDR sensor. In FIG. 6, each of the image frames 610, 620, 630 are captured by the SHDR sensor with a different exposure time. For example, image frame 610 is captured by the SHDR sensor with a short exposure time, image frame 620 is captured by the SHDR sensor with a medium exposure time, and image frame 630 is captured by the SHDR sensor with a long exposure time. The medium exposure time is longer in duration than the short exposure time, and the long exposure time is longer in duration than the medium exposure time. The image frames 610, 620, 630 of the scene are captured by the SHDR sensor during an active-frame duration (e.g., an active frame window). The image frames 610, 620, 630 can be combined together to generate an HDR image frame 640 of the scene.

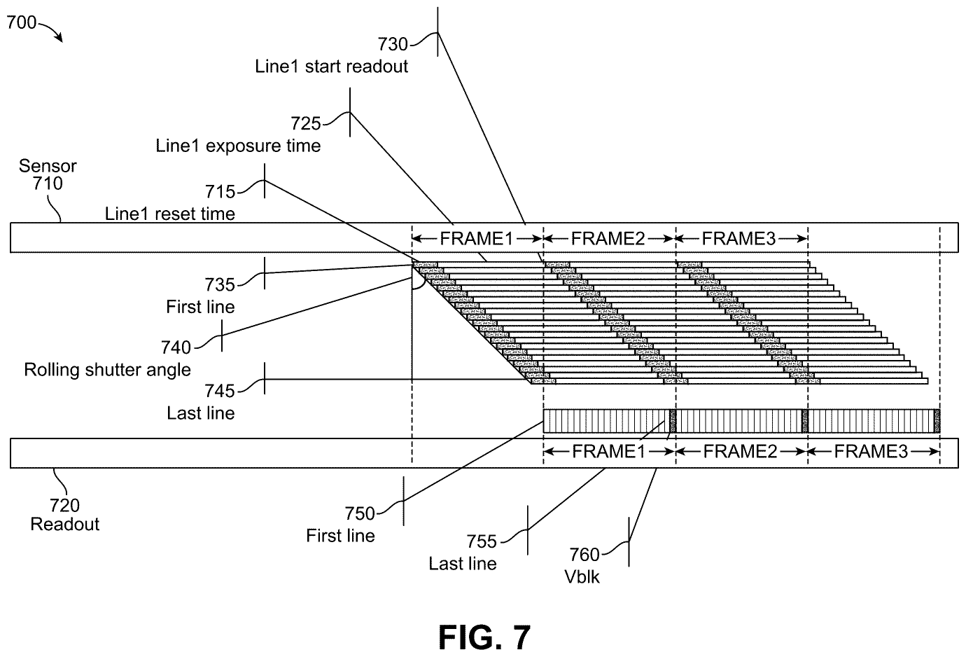

As mentioned, Bayer sensors have a constant sensor data rate through an active-frame duration (e.g., an active frame window). FIG. 7 shows an example Bayer sensor exposure and readout pattern, which illustrates a constant sensor data rate in the readout. In particular, FIG. 7 is a diagram illustrating an example of an exposure and readout pattern 700 of sensor data captured by a Bayer sensor. In FIG. 7, the exposure and readout pattern 700 is shown to include a sensor data stream 710 and a readout stream 720. A horizontal axis of the exposure and readout pattern 700 denotes time.

The sensor data stream 710 is shown to include three image frames (e.g., frame 1, frame 2, and frame 3). The three image frames together make up a single active-frame duration (e.g., an active-frame window) of a scene. In the sensor data stream 710, each of the image frames (e.g., frame 1, frame 2, and frame 3) is output from the Bayer sensor from a first line (e.g., first line 735 for frame 1) to a last line (e.g., last line 745 of frame 1). The lines from the first line to the last line are shown to be staggered in time at a rolling shutter angle 740. The sensor data pattern 710 also shows the first line (line 1) reset time 715 for frame 1, the first line (line 1) exposure time 725 for frame 1, and the first line (line 1) start readout 730 for frame 1.

The readout stream 720 is also shown to include the three image frames (e.g., frame 1, frame 2, and frame 3). In the readout stream 720, the three image frames are shown to be read out consecutively one after another (e.g., with vertical blanking (Vblk) interval 760 located between the adjacent image frames). For example, in the readout stream 720, frame 1 is shown to be read out from a time of the first line 750 to a time of the last line 755. As such, the three image frames are shown to be read out at a constant data rate.

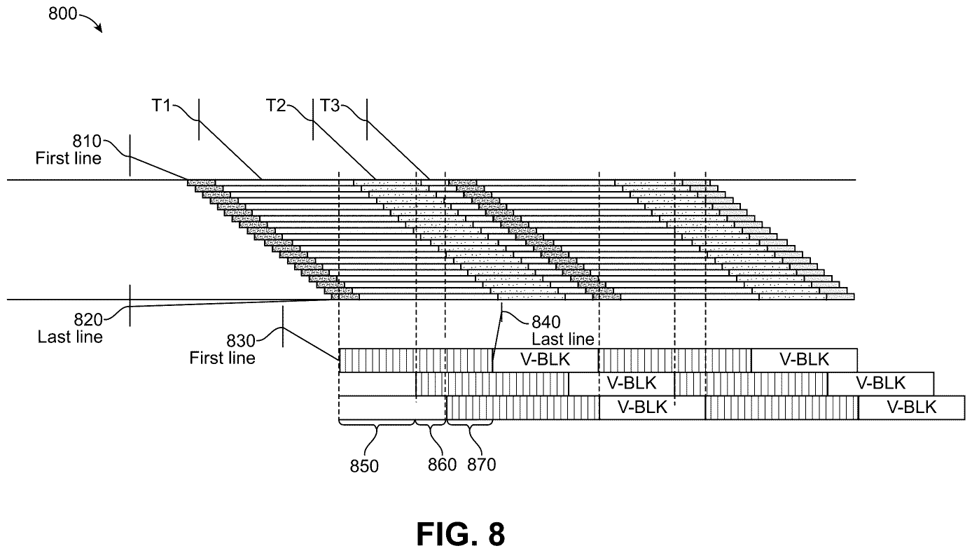

Conversely to Bayer sensors, SHDR sensors have a variable sensor data rate through an active-frame duration (e.g., an active frame window). FIG. 8 is a diagram illustrating an example of an exposure and readout pattern 800 of sensor data captured by an SHDR sensor. In FIG. 8, the exposure and readout pattern 800 is shown to include a sensor data stream and a readout stream. A horizontal axis of the exposure and readout pattern 800 denotes time.

The sensor data stream is shown to include three image frames (e.g., T1, T2, and T3). The three image frames together form a single active-frame duration (e.g., an active-frame window) of a scene. In the sensor data stream, each of the image frames (e.g., T1, T2, and T3) is output from the SHDR sensor from a first line (e.g., first line 810 for T1) to a last line (e.g., last line 820 of T1). The lines from the first line to the last line are shown to be staggered in time.

The readout stream includes the three image frames (e.g., T1, T2, and T3). In the readout stream, the three image frames (e.g., T1, T2, and T3) are shown to be read out in a staggered fashion. In the readout stream, T1 is shown to be read out from a time of the first line 830 to a time of the last line 840. At different durations of time during the readout steam, different amounts of data are read out. For example, during time duration 850, only data for T1 is read out. Since only data from one image frame (e.g., T1) is read out, a slow data rate may be used during time duration 850. During time duration 860, data for T1 and T2 is read out. During time duration 870, data for all three image frames (e.g., T1, T2, and T3) is read out. Since data from all three image frames is read out, a high data rate is needed during time duration 870. As such, the three image frames are shown to be read out at a variable data rate.

As mentioned, existing DRV schemes cannot dynamically vote based on intraframe activity. As such, existing DRV schemes are unable to scale down the processing (e.g., the ISP and DDR clock rate) during periods of a low sensor data rate to allow for a conservation of the sensor power.

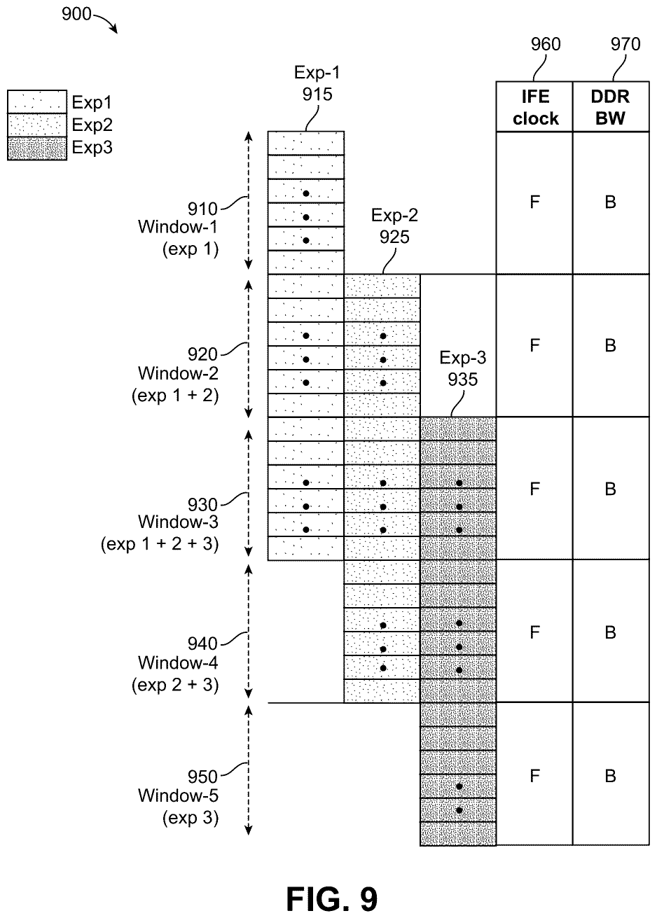

FIG. 9 shows an example of this limitation (e.g., unable to dynamically vote based on intraframe activity) of existing DRV schemes. In particular, FIG. 9 is a diagram illustrating an example of a readout pattern 900 of sensor data (e.g., image data) captured by an SHDR sensor with corresponding constant frequency and bandwidth settings for processing the sensor data, where the settings are generated based on dynamic resource voting (e.g., existing DRV schemes). In FIG. 9, the readout pattern 900 shows an SDHR sensor readout of image data (e.g., including a plurality of image frames) during one active-frame duration (e.g., an active-frame window). The image frames each have an exposure time, which may be exposure 1 (exp-1) 915, exposure 2 (exp-2) 925, or exposure 3 (exp-3) 935. Each of the exposure times have a different duration of time for the exposure of the image frames.

The active-frame duration is divided into five windows of time, including window 1 910, window 2 920, window 3 930, window 4 940, and window 5 950. A vertical axis of the readout pattern 900 denotes time (e.g., starting from the top of the vertical axis). The active-frame duration is divided into a number of windows based on (e.g., depending upon) a number of exposure times of image frames transmitted during that particular window. During window 1 910, frames with exposure 1 (exp-1) 915 are transmitted. During window 2 920, frames with exposure 1 (exp-1) 915 and exposure 2 (exp-2) 925 are transmitted. During window 3 930, frames with exposure 1 (exp-1) 915, exposure 2 (exp-2) 925, and exposure 3 (exp-3) 935 are transmitted. During window 4 940, frames with exposure 2 (exp-2) 925 and exposure 3 (exp-3) 935 are transmitted. During window 5 950, frames with exposure 3 (exp-3) 935 are transmitted.

Window 3 930, where frames for all three of the different exposure times are transmitted together, has a peak sensor data rate. As such, as shown in FIG. 9, for window 3 930, the IFE clock frequency 960 is set to a peak frequency (e.g., as denoted as F) and the DDR bandwidth 970 is set to a peak bandwidth (e.g., as denoted as B). The IFE clock frequency 960 and the DDR bandwidth 970 for the other windows (e.g., window 1 910, window 2 920, window 4 940, and window 5 950) are set based on the peak requirements of window 3 930.

Even though the sensor data rate for the other windows (e.g., window 1 910, window 2 920, window 4 940, and window 5 950) is lower than the sensor data rate for window 3 930, the IFE clock frequency 960 and the DDR bandwidth 970 settings are kept static based on the peak requirements of window 3 930. These static IFE clock frequency 960 and the DDR bandwidth 970 settings can cause a significant power overhead for an SOC. SOC power can be conserved by scaling (e.g., scaling down) the IFE clock frequency 960 and the DDR bandwidth 970 settings based on the data rates of each window.

Therefore, improved systems and techniques for a DRV scheme that allow for a scaling down in processing (e.g., the ISP and DDR clock rate) during periods of a low sensor data rate can be useful (e.g., because existing DRV schemes cannot dynamically scale down or up based on intraframe activity).

In one or more aspects, the systems and techniques provide gaze and exposure based dynamic resource voting. In one or more examples, the systems and techniques provide solutions that conserve intraframe ISP and SOC power for sensors (e.g., SHDR sensors and foveated sensors), where the sensor data rate varies within the active-frame duration. In some examples, the systems and techniques provide an intraframe DRV scheme that produces dynamic intraframe votes for different windows of a sensor readout of an active-frame duration, where the votes are generated based on the data rate of respective windows of the active-frame duration.

In one or more examples, during operation of the systems and techniques for image processing, one or more sensors may receive image data including a plurality of frames of a scene for one active-frame duration, wherein the image data is divided into a plurality of windows, each window of the plurality of windows being associated with a respective data rate. One or more processors may determine, based on the respective data rate of each window of the plurality of windows, a respective processing scaling factor for each window of the plurality of windows for processing the image data. The one or more processors may process, based on the respective processing scaling factor determined for each window, the image data.

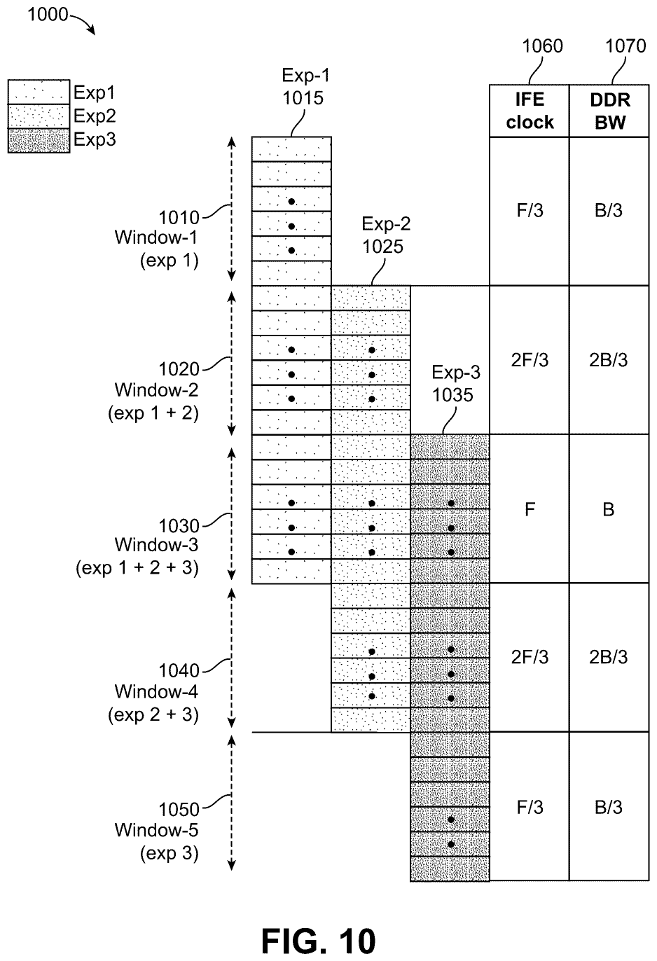

FIG. 10 shows an example of a DRV scheme of the systems and techniques that can dynamically scale (e.g., vote) based on intraframe activity. In particular, FIG. 10 is a diagram illustrating an example of a readout pattern 1000 of sensor data captured by an SHDR sensor with corresponding varying frequency and bandwidth settings for processing the sensor data, where the settings are generated based on exposure-based dynamic resource voting. In FIG. 10, the readout pattern 1000 shows an SDHR sensor readout of image data (e.g., including a plurality of image frames) during one active-frame duration (e.g., an active-frame window). The image frames each have an exposure time. The exposure time may be exposure 1 (exp-1) 1015, exposure 2 (exp-2) 1025, or exposure 3 (exp-3) 1035. Each exposure time has a different duration of time for the exposure of the image frames.

The active-frame duration is divided into five windows of time, which include window 1 1010, window 2 1020, window 3 1030, window 4 1040, and window 5 1050. A vertical axis of the readout pattern 1000 denotes time.

The DRV scheme of the systems and techniques can generate dynamic intraframe votes for different windows of the readout pattern 1000. The votes can be generated based on the data rate of each of the windows. In FIG. 10, the IFE clock frequency 1060 is set to a peak frequency (e.g., as denoted as F) and the DDR bandwidth 1070 is set to a peak bandwidth (e.g., as denoted as B) only for a fraction of the time duration of the active-frame duration.

As shown in FIG. 10, the IFE clock frequency 1060 is set to a peak frequency (e.g., as denoted as F) and the DDR bandwidth 1070 is set to a peak bandwidth (e.g., as denoted as B) only during window 3 1030, where frames for all three of the different exposure times are transmitted together. During the other windows (e.g., window 1 1010, window 2 1020, window 4 1040, and window 5 1050), the IFE clock frequency 1060 and the DDR bandwidth 1070 are scaled down, based on the particular sensor data rate for that window. For example, for window 2 1020 and window 4 1040, the IFE clock frequency 1060 is set to 2F/3 and the DDR bandwidth 1070 is set to 2B/3. For window 1 1010 and window 5 1050, the IFE clock frequency 1060 is set to F/3 and the DDR bandwidth 1070 is set to B/3. The scaling (e.g., scaling down) of the IFE clock frequency 960 and the DDR bandwidth 970 settings can save significant sensor power during window 1 1010, window 2 1020, window 4 1040, and window 5 1050.

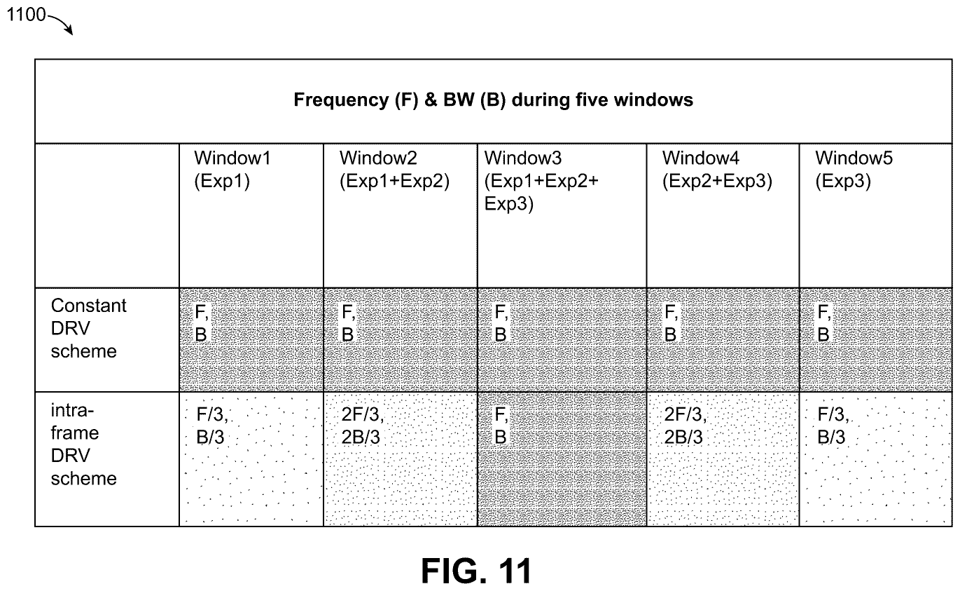

FIG. 11 shows a table with a comparison of example IFE clock frequency and the DDR bandwidth settings for different windows generated by an existing DRV scheme (e.g., which is unable to dynamically vote based on intraframe activity and, as such, uses constant settings) and by a DRV scheme of the systems and techniques (e.g., which can dynamically vote based on intraframe activity). In particular, FIG. 11 is a table 1100 illustrating examples of frequency and bandwidth settings for processing sensor data captured by an SHDR sensor, where the settings are generated based on existing dynamic resource voting (e.g., as shown in FIG. 9) and exposure-based dynamic resource voting (e.g., as shown in FIG. 10). In FIG. 11, the columns of the table 1100 each represent a different window (e.g., windows 1, 2, 3, 4, and 5) of an active-frame duration, and the rows of the table 1100 each represent a different DRV scheme used to determine the frequency and bandwidth settings. The different DRV schemes include a constant DRV scheme (e.g., an existing DRV scheme, such as used for the example of FIG. 9) and an intraframe DRV scheme (e.g., a DRV scheme of the systems and techniques, such as used for the example of FIG. 10).

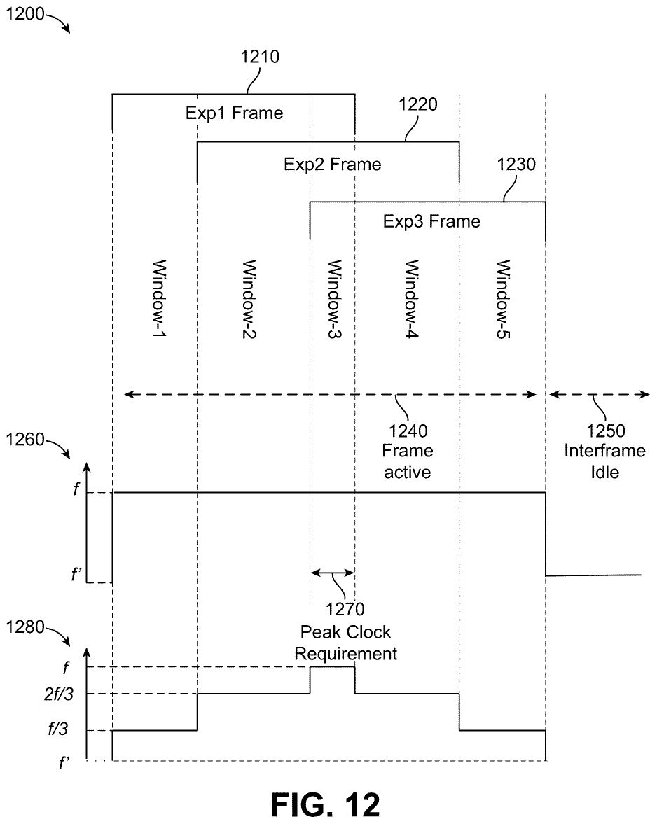

FIG. 12 shows a comparison of examples of IFE clock frequency settings for different windows generated by an existing DRV scheme (e.g., which is unable to dynamically vote based on intraframe activity and, as such, uses constant settings) and by a DRV scheme of the systems and techniques (e.g., which can dynamically vote based on intraframe activity). In particular, FIG. 12 is a diagram illustrating examples of frequency settings for processing sensor data captured by an SHDR sensor, where the settings are generated based on existing dynamic resource voting and exposure-based dynamic resource voting. In FIG. 12, a readout pattern 1200 of image frames captured by an SHDR sensor is shown. The readout pattern 1200 is shown to include image frames with three different exposure times, including exposure 1 (Exp 1) 1210, exposure 2 (Exp 2) 1220, and exposure 3 (Exp 3) 1230. The image frames are captured by the SHDR sensor during an active-frame duration (e.g., a frame active 1240 duration). The active-frame duration is divided into a number of windows, including window 1, window 2, window 3, window 4, and window 5. A duration of idleness (e.g., an interframe idle 1250) is shown to occur after the active-frame duration. During the duration of idleness, no processing of image frames occurs.

In FIG. 12, a graph 1260 is shown with IFE clock frequency settings for the windows during the active-frame duration as generated by an existing DRV voting scheme. In graph 1260, the IFE clock frequency settings for all of the windows are shown to be constant at a peak frequency (e.g., as denoted as f).

FIG. 12 also shows graph 1280, which shows IFE clock frequency settings for the windows during the active-frame duration as generated by a DRV voting scheme of the systems and techniques. In graph 1280, the IFE clock frequency settings are shown to vary (e.g., be scaled) according to the different data rates of the different windows. During duration 1270 of graph 1280, for window 3 (e.g., when image frames with all three of the different exposure times are transmitted), the IFE clock frequency setting is shown to be at the peak frequency (e.g., f). In the graph 1280, the peak IFE clock frequency setting is maintained only during window 3.

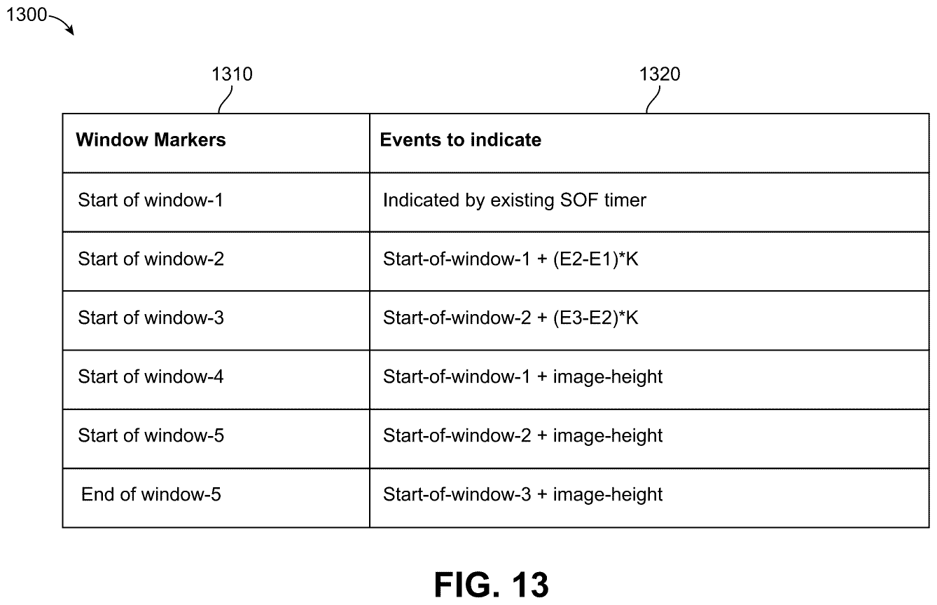

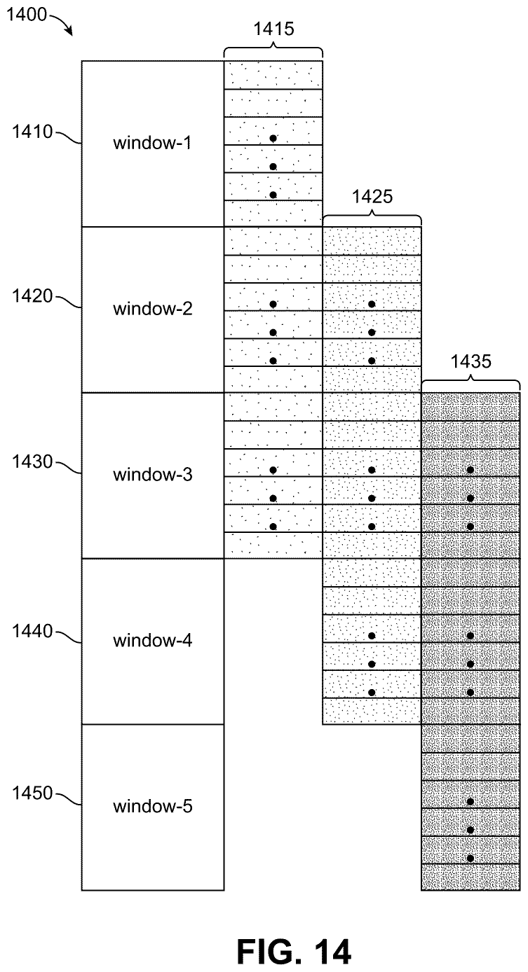

In one or more aspects, the start (e.g., start time) and end (e.g., end time) of windows of an active-frame duration can be determined (e.g., computed) via exposure time and image frame height. FIGS. 13 and 14 together shows examples of different events to determine indicate markers for starts (e.g., start times) of different windows of an active-frame duration. In particular, FIG. 13 is a table 1300 illustrating examples of events to indicate markers for windows of a readout of sensor data captured by an SHDR sensor. FIG. 14 is a diagram illustrating examples of windows of a readout 1400 of sensor data captured by an SHDR sensor.

In FIG. 14, the readout 1400 shows an SDHR sensor readout of image data (e.g., including a plurality of image frames) during one active-frame duration (e.g., an active-frame window). The image frames each have an exposure time, which may be exposure 1 (E1) 1415, exposure 2 (E2) 1425, or exposure 3 (E3) 1435. Each of the exposure times have a different duration of time for the exposure of the image frames.

The active-frame duration is divided into five windows of time, including window 1 1410, window 2 1420, window 3 1430, window 4 1440, and window 5 1450. A vertical axis of the readout 1400 denotes time (e.g., starting from the top of the vertical axis). During window 1 1410, frames with exposure 1 (E1) 1415 are transmitted. During window 2 1420, frames with exposure 1 (E1) 1415 and exposure 2 (E2) 1425 are transmitted. During window 3 1430, frames with exposure 1 (E1) 1415, exposure 2 (E2) 1425, and exposure 3 (E3) 1435 are transmitted. During window 4 1440, frames with exposure 2 (E2) 1425 and exposure 3 (E3) 1435 are transmitted. During window 5 1450, frames with exposure 3 (E3) 1435 are transmitted.

In FIG. 13, the table 1300 includes a window markers column 1310 and an events to indicate column 1320. The window markers column 1310 indicates the start (e.g., start time) of a particular window of FIG. 14. The events to indicate column 1320 indicates specific events in the readout 1400 that can indicate the starts (e.g., start times) and ends (e.g., end times) of the different windows.

In the table 1300, an existing start of frame (SOF) timer can indicate the start (e.g., start time) of window 1 1410. Also shown in table 1300, the start of window 2 1420 can be indicated by the start (e.g., start time) of window 1 1410 plus E2-E1 (e.g., the difference between the start time of the first image frame with exposure 2 (E2) 1425 minus the start time of the first image frame with exposure 1 (E1) 1415) multiplied by a constant K (e.g., a constant for some delay for the particular SHDR sensor). The start of window 3 1430 can be indicated by the start (e.g., start time) of window 2 1420 plus E3-E2 (e.g., the difference between the start time of the first image frame with exposure 3 (E3) 1435 minus the start time of the first image frame with exposure 2 (E2) 1425) multiplied by the constant K.

Table 1300 also shows that the start (e.g., start time) of window 4 1440 can be indicated by the start (e.g., start time) of window 1 1410 plus the image height (e.g., the end time of the last image with exposure 1 (E1) 1415 minus the start time of the first image with exposure 1 (E1) 1415). The start of window 5 1450 can be indicated by the start (e.g., start time) of window 2 1420 plus the image height (e.g., the end time of the last image with exposure 2 (E2) 1425 minus the start time of the first image with exposure 2 (E2) 1425). The end (e.g., end time) of window 5 1450 can be indicated by the start (e.g., start time) of window 3 1430 plus the image height (e.g., the end time of the last image with exposure 3 (E3) 1435 minus the start time of the first image with exposure 3 (E3) 1435).

In one or more aspects, for the DRV scheme of the systems and techniques, vote scaling occurs intraframe. It is not practical for the voting to be software controlled due to software latency. As such, for a robust solution, a hardware based scheme, which does not require any software intervention, may be employed.

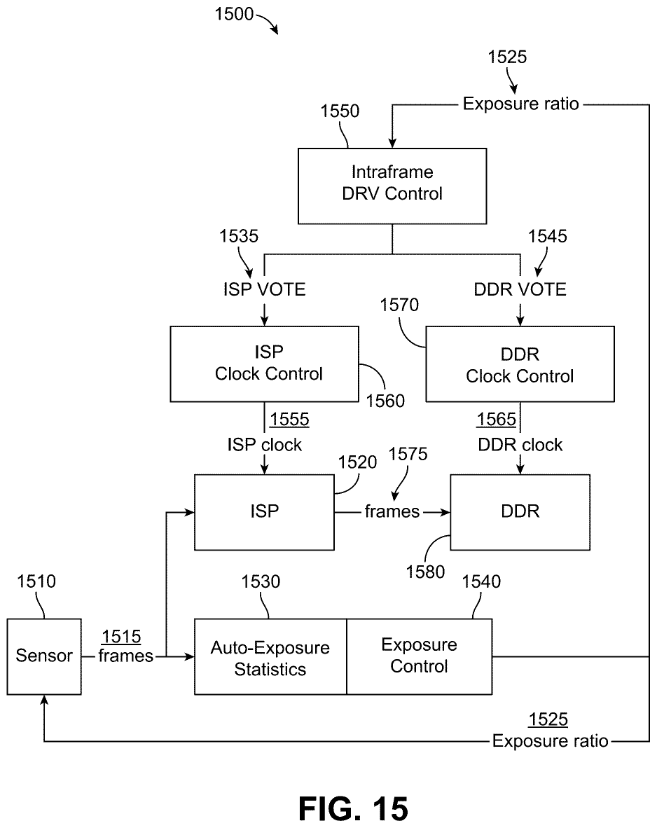

FIG. 15 shows an example of a hardware-based system for exposure-based dynamic resource voting. In particular, FIG. 15 is a diagram illustrating an example of a system 1500 for exposure-based dynamic resource voting. In FIG. 15, the system 1500 is shown to include a sensor 1510 (e.g., an HDR sensor, such as an SHDR sensor), an ISP 1520, an auto-exposure statistics engine 1530, an exposure control engine 1540, an intraframe DRV control engine 1550, an ISP clock control engine 1560, a DDR clock control engine 1570, and a DDR memory 1580.

During operation of the system 1500 of FIG. 15, the sensor 1510 can receive image data including a plurality of frames 1515 of a scene for one active-frame duration. The image data (e.g., of the active-frame duration) can be divided into a plurality of windows (e.g., five windows). Each frame of the plurality of frames 1515 can have a respective exposure time of a plurality of exposure times (e.g., three different exposure times).

The sensor 1510 can transmit the frames 1515 to the ISP 1520 and to the auto-exposure statistics engine 1530. One or more processors (e.g., of the auto-exposure statistics engine 1530) can determine, based on the frames 1515, the auto-exposure statistics (e.g., AF, AE or AWB statistics) of the frames 1515. The one or more processors (e.g., of the auto-exposure statistics engine 1530) can determine, based on the auto-exposure statistics of the frames 1515, the respective exposure time of each frame of the plurality of frames 1515. The auto-exposure statistics engine 1530 can send, to the exposure control engine 1540, the respective exposure time of each frame of the plurality of frames 1515.

One or more processors (e.g., of the exposure control engine 1540) can determine, based on the respective exposure time of each frame of the plurality of frames, a respective exposure ratio 1525 for each exposure time of the plurality of exposure times. The exposure control engine 1540 can send, to the sensor 1510 and to the intraframe DRV control engine 1550, the respective exposure ratio 1525 for each exposure time of the plurality of exposure times. The sensor 1510 can adjust, based on the respective exposure ratio 1525 for each exposure time of the plurality of exposure times, the exposure ratio for subsequent frames.

One or more processors (e.g., of an intraframe DRV control engine 1550) can determine, based on the respective exposure ratio 1525 for each exposure time of the plurality of exposure times, a respective start time (and respective end time) and a respective processing scaling factor for each window of the plurality of windows. The one or more processors (e.g., of the intraframe DRV control engine 1550) can send, at the respective start time of each window of the plurality of windows based on the respective processing scaling factor determined for each window of the plurality of windows, a respective command (e.g., a vote) for adjusting a frequency and a bandwidth for processing the image data. In one or more examples, the respective command can be an ISP vote 1535 (e.g., a vote up or vote down) and/or a DDR vote 1545 (e.g., a vote up or vote down). In some examples, the intraframe DRV control engine 1550 can send the ISP vote 1535 to the ISP clock control engine 1560, and send the DDR vote 1545 to the DDR clock control engine 1570.

One or more processors (e.g., of the ISP clock control engine 1560) can modulate, based on the ISP vote 1535, a corresponding clock frequency (e.g., an ISP clock 1555) for a clock of the ISP 1520 to change a frequency of the ISP 1520 for processing the frames 1515.

One or more processors (e.g., of the DDR clock control engine 1570) can modulate, based on the DDR vote 1545, a corresponding clock frequency (e.g., a DDR clock 1565) for a clock of the DDR memory 1580 to change a bandwidth of the DDR memory 1580 for processing and storing the frames.

The one or more processors (e.g., of the ISP 1520) can process, based on the frequency of the ISP 1520 for processing, the frames 1515 to generate processed frames 1575. The ISP 1520 can send the processed frames 1575 to the DDR memory 1580. The one or more processors (e.g., of the DDR memory 1580) can, based on the bandwidth, process and store the processed frames 1575.

In one or more aspects, foveated sensors are prominent in XR device platforms. For example, foveated sensors are primarily used for VR products, such as for VST use cases. For foveated sensors, based on an eye gaze location (e.g., a gaze of a user's eye), image frames for three different regions of a scene are captured and transmitted. These three regions include a fovea region (e.g., a small window or region of the scene with a high resolution), a middle or intermediate region (e.g., a medium window or region of the scene with a medium resolution, such as subsampled by two), and a periphery region (e.g., a large window or region or field of view of the scene with a low resolution, such as subsampled by four).

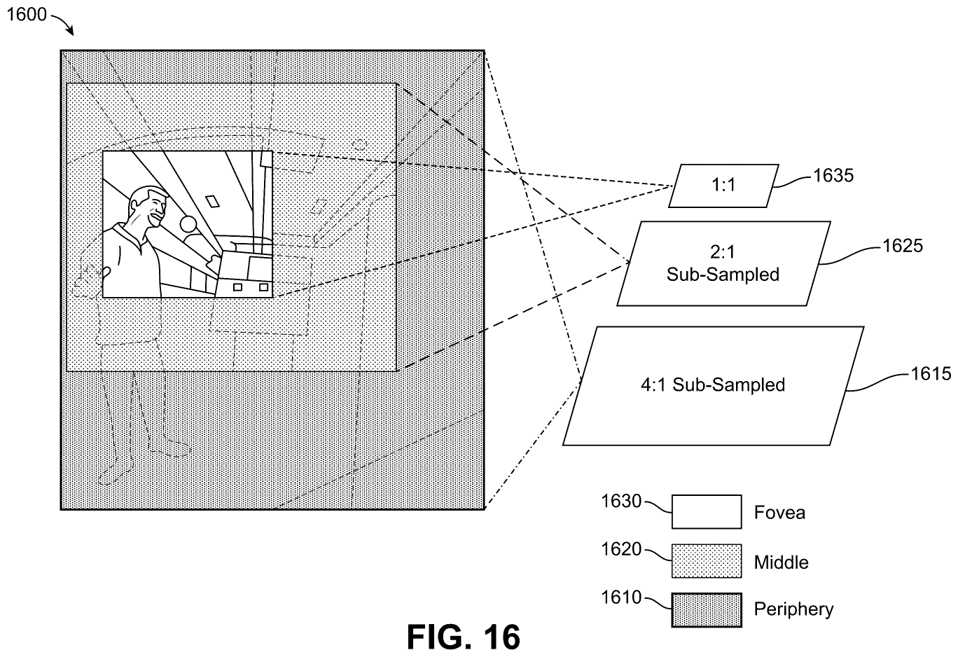

FIG. 16 shows example regions captured by a foveated sensor. In particular, FIG. 16 is a diagram illustrating examples 1600 of different regions with different resolutions captured of a scene by a foveated sensor. In FIG. 16, the different regions include a fovea region 1630, a middle region 1620, and a periphery region 1610. In one or more examples, the fovea region 1630 has full resolution sampling 1635 (e.g., 1:1), the middle region 1620 is sub-sampled by 2 1625 (e.g., 2:1), and the periphery region 1610 is sub-sampled by 4 1615 (e.g., 4:1).

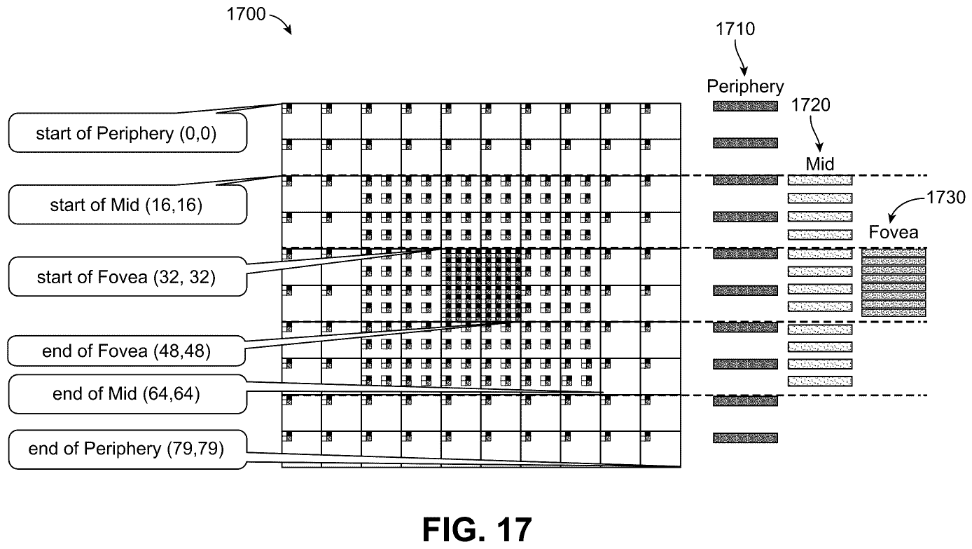

FIG. 17 shows an example readout pattern of foveated sensor data. In particular, FIG. 17 is a diagram illustrating an example of a readout pattern 1700 of sensor data captured by a foveated sensor. In FIG. 17, the readout pattern 1700 includes sensor data (e.g., image frames) captured for the three regions, which include the periphery region data 1710, the middle region data 1720, and the fovea region data 1730. The readout pattern 1700 can be divided into a grid of pixels with X, Y coordinates. In FIG. 17, the readout pattern 1700 shows the start pixel (e.g., start coordinates of a start pixel) and end pixel (e.g., end coordinates of an end pixel) for each of the three regions.

As mentioned, existing DRV schemes are unable to dynamically vote based on intraframe activity. Thus, existing DRV schemes are unable to scale down the processing (e.g., the ISP and DDR clock rate) during periods of a low sensor data rate to allow for a conservation of the sensor power.

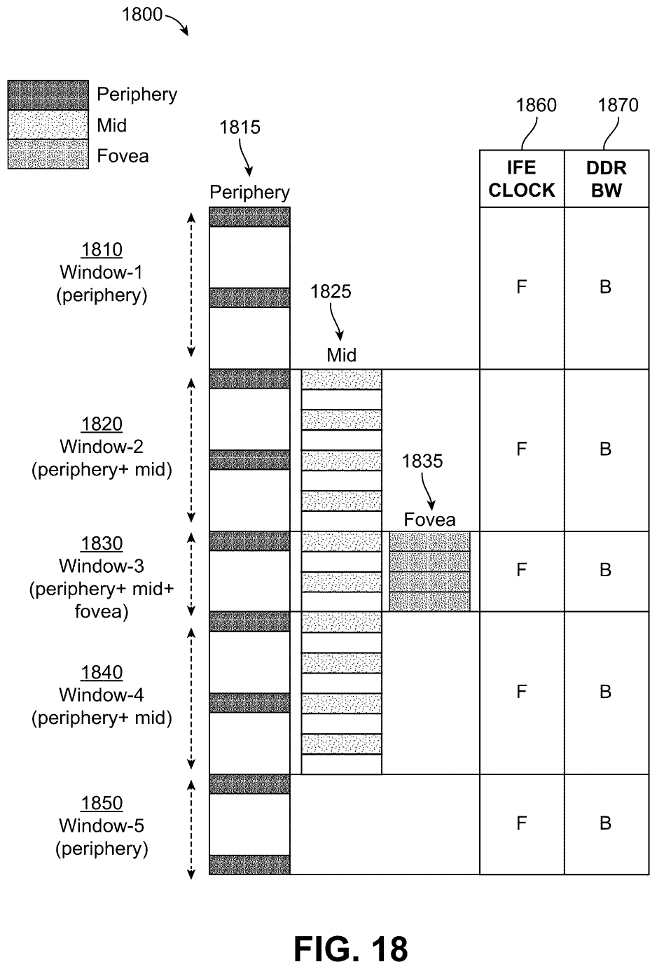

FIG. 18 shows an example of this limitation (e.g., unable to dynamically vote based on intraframe activity) of existing DRV schemes. In particular, FIG. 18 is a diagram illustrating an example of a readout pattern 1800 of sensor data captured by a foveated sensor with corresponding constant frequency and bandwidth settings for processing the sensor data, where the settings are generated based on dynamic resource voting (e.g., existing DRV schemes). In FIG. 18, the readout pattern 1800 shows a foveated sensor readout of image data (e.g., including a plurality of image frames) during one active-frame duration (e.g., an active-frame window). Each of the image frames correspond to a region, which may be a periphery region 1815, a middle region 1825, or a fovea region 1835.

The active-frame duration is divided into five windows of time, including window 1 1810, window 2 1820, window 3 1830, window 4 1840, and window 5 1850. A vertical axis of the readout pattern 1800 denotes time (e.g., starting from the top of the vertical axis). The active-frame duration is divided into a number of windows based on (e.g., depending upon) a number of exposure times of image frames transmitted during that particular window. During window 1 1810, frames corresponding to the periphery region 1815 are transmitted. During window 2 1820, frames corresponding to the periphery region 1815 and frames corresponding to the middle region 1825 are transmitted. During window 3 1830, frames corresponding to the periphery region 1815, frames corresponding to the middle region 1825, and frames corresponding to the fovea region 1835 are transmitted. During window 4 1840, frames corresponding to the middle region 1825 and frames corresponding to the fovea region 1835 are transmitted. During window 5 1850, frames corresponding to the fovea region 1835 are transmitted.

Window 3 1830, where frames corresponding to all three of the different regions are transmitted together, has a peak sensor data rate. Thus, as shown in FIG. 18, for window 3 1830, the IFE clock frequency 1860 is set to a peak frequency (e.g., as denoted as F) and the DDR bandwidth 1870 is set to a peak bandwidth (e.g., as denoted as B). The IFE clock frequency 1860 and the DDR bandwidth 1870 for the other windows (e.g., window 1 1810, window 2 1820, window 4 1840, and window 5 1850) are set based on the peak requirements of window 3 1830.

Although the sensor data rate for the other windows (e.g., window 1 1810, window 2 1820, window 4 1840, and window 5 1850) is lower than the sensor data rate for window 3 1830, the IFE clock frequency 1860 and the DDR bandwidth 1870 settings are kept static based on the peak requirements of window 3 1830. These static IFE clock frequency 1860 and the DDR bandwidth 1870 settings can result in a large sensor power overhead. Sensor power can be saved by scaling (e.g., scaling down) the IFE clock frequency 1860 and the DDR bandwidth 1870 settings based on the data rates of each window.

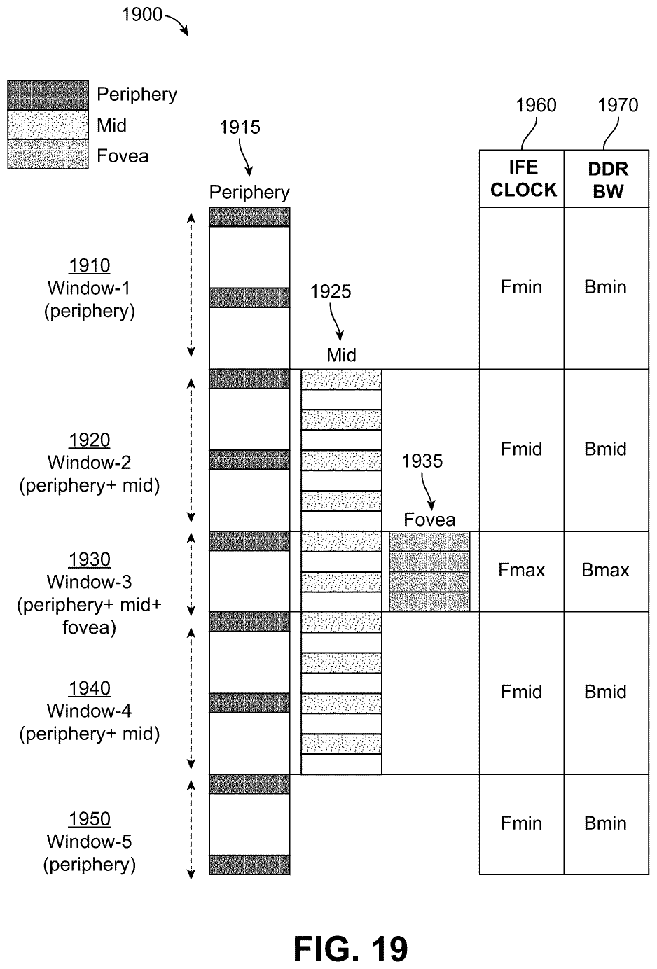

FIG. 19 shows an example of a DRV scheme of the systems and techniques that can dynamically scale (e.g., vote) based on intraframe activity. In particular, FIG. 19 is a diagram illustrating an example of a readout pattern 1900 of sensor data captured by a foveated sensor with corresponding varying frequency and bandwidth settings for processing the sensor data, where the settings are generated based on gaze-based dynamic resource voting. In FIG. 19, the readout pattern 1900 shows a foveated sensor readout of image data (e.g., including a plurality of image frames) during one active-frame duration (e.g., an active-frame window). The image frames each correspond to a different region. The region may be a periphery region 1915, a middle region 1925, or a fovea region 1935. Each region has a different resolution. The active-frame duration is divided into five windows of time, which include window 1 1910, window 2 1920, window 3 1930, window 4 1940, and window 5 1950. A vertical axis of the readout pattern 1000 denotes time.

The DRV scheme of the systems and techniques can produce dynamic intraframe votes for different windows of the readout pattern 1900. The votes can be generated based on the data rate of each of the windows. In FIG. 19, the IFE clock frequency 1960 is set to a peak frequency (e.g., as denoted as Fmax) and the DDR bandwidth 1970 is set to a peak bandwidth (e.g., as denoted as Bmax) only for a fraction of the time duration of the active-frame duration.

As shown in FIG. 19, the IFE clock frequency 1960 is set to a peak frequency (e.g., as denoted as Fmax) and the DDR bandwidth 1970 is set to a peak bandwidth (e.g., as denoted as Bmax) only during window 3 1930, where frames corresponding to all three regions are transmitted together. During the other windows (e.g., window 1 1910, window 2 1920, window 4 1940, and window 5 1950), the IFE clock frequency 1960 and the DDR bandwidth 1970 are scaled down, based on the particular sensor data rate for that window. For example, for window 2 1920 and window 4 1940, the IFE clock frequency 1960 is set to Fmid and the DDR bandwidth 1970 is set to Bmid. For window 1 1910 and window 5 1950, the IFE clock frequency 1960 is set to Fmin and the DDR bandwidth 1970 is set to Bmin. In one or more examples, Fmax is greater than Fmid, which is greater than Fmin. In some examples, Bmax is greater than Bmid, which is greater than Bmin. The scaling (e.g., scaling down) of the IFE clock frequency 1960 and the DDR bandwidth 1970 settings can conserve sensor power during window 1 1910, window 2 1920, window 4 1940, and window 5 1950.

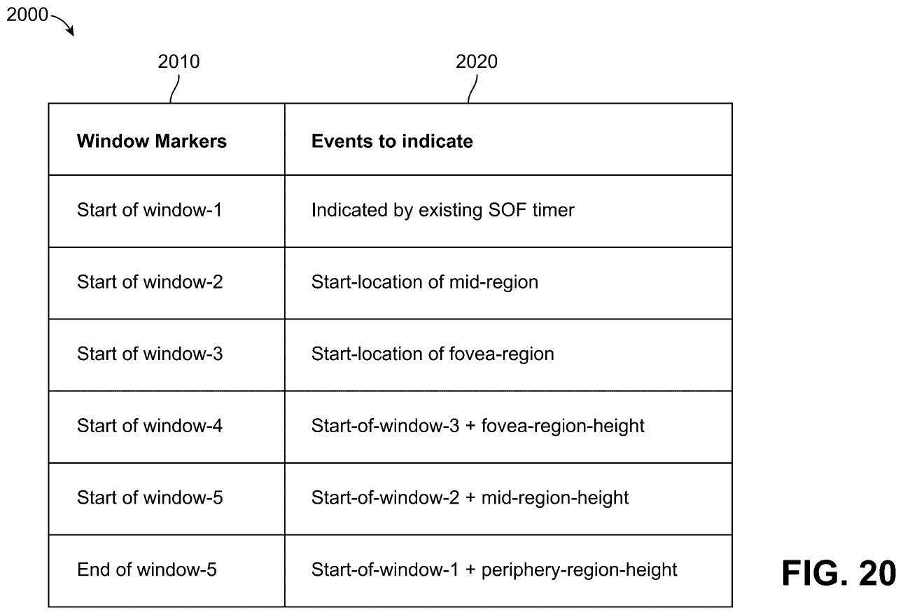

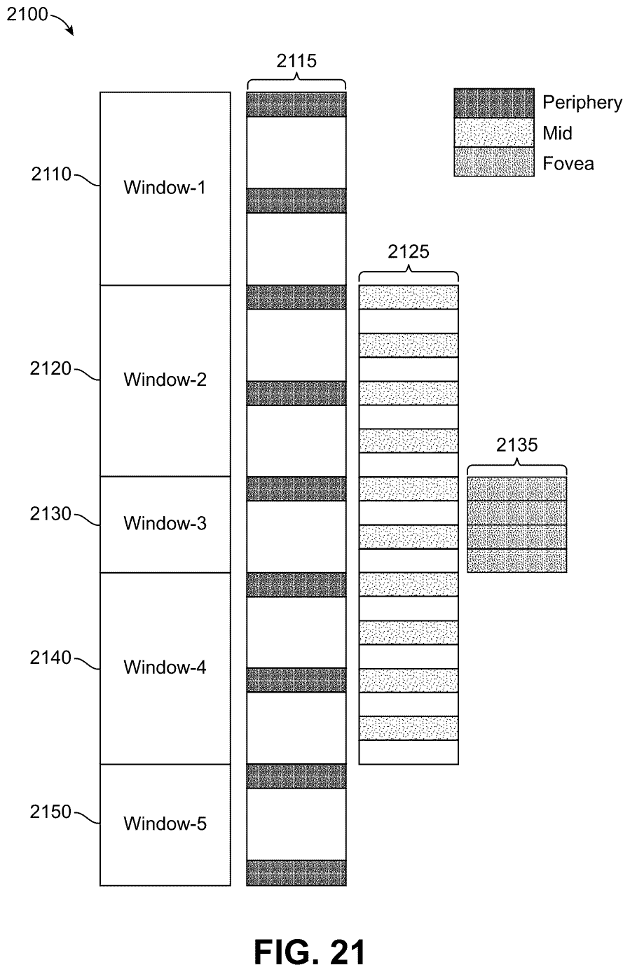

In one or more aspects, the start (e.g., start time) and end (e.g., end time) of windows of an active-frame duration can be determined (e.g., computed) via eye gaze location of a user associated with a foveated sensor. FIGS. 20 and 21 together shows examples of different events to determine indicate markers for starts (e.g., start times) of different windows of an active-frame duration. In particular, FIG. 20 is a table 2000 illustrating examples of events to indicate markers for windows of a readout of sensor data captured by a foveated sensor. FIG. 21 is a diagram illustrating examples of windows of a readout 2100 of sensor data captured by a foveated sensor. In FIG. 21, the readout 2100 shows a foveated sensor readout of image data (e.g., including a plurality of image frames) during one active-frame duration (e.g., an active-frame window). The image frames each correspond to a region, which may be a periphery region 2115, a middle region 2125, or a fovea region 2135. Each of the regions has a different resolution.

The active-frame duration is divided into five windows of time, including window 1 2110, window 2 2120, window 3 2130, window 4 2140, and window 5 2150. A vertical axis of the readout 2100 denotes time (e.g., starting from the top of the vertical axis). During window 1 2110, frames corresponding to the periphery region 2115 are transmitted. During window 2 2120, frames corresponding to the periphery region 2115 and frames corresponding to the middle region 2125 are transmitted. During window 3 2130, frames corresponding to the periphery region 2115, frames corresponding to the middle region 2125, and frames corresponding to the fovea region 2135 are transmitted. During window 4 2140, frames corresponding to the middle region 2125 and frames corresponding to the fovea region 2135 are transmitted. During window 5 2150, frames corresponding to the fovea region 2135 are transmitted.

In FIG. 20, the table 2000 includes a window markers column 2010 and an events to indicate column 2020. The window markers column 2010 indicates the start (e.g., start time) of a particular window of FIG. 21. The events to indicate column 2020 indicates specific events in the readout 2100 that can indicate the starts (e.g., start times) and ends (e.g., end times) of the different windows.

In the table 2000, an existing start of frame (SOF) timer can indicate the start (e.g., start time) of window 1 2110. Also shown in table 2000, the start of window 2 2120 can be indicated by the start location of the middle region 2125. The start of window 3 2130 can be indicated by the start location of the fovea region 2135.

Table 2000 also shows that the start (e.g., start time) of window 4 2140 can be indicated by the start (e.g., start time) of window 3 2130 plus the height of the fovea region 2135. The start (e.g., start time) of window 5 2150 can be indicated by the start (e.g., start time) of window 2 2120 plus the height of the middle region 2125. The end (e.g., end time) of window 5 2150 can be indicated by the start (e.g., start time) of window 1 2110 plus the height of the periphery region 2115.

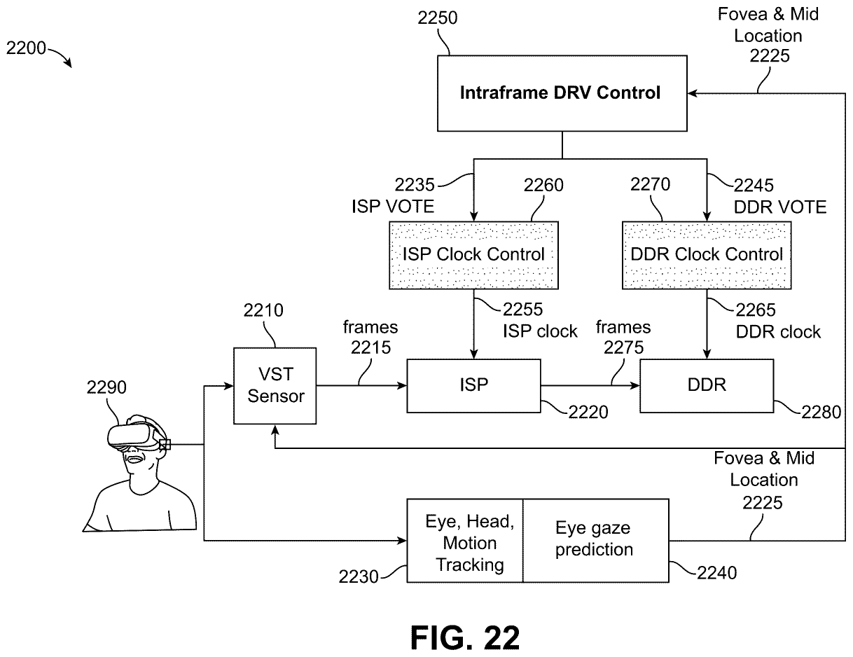

FIG. 22 shows an example of a hardware-based system for gaze-based dynamic resource voting. In particular, FIG. 22 is a diagram illustrating an example of a system 2200 for gaze-based dynamic resource voting. In FIG. 22, the system 2200 is shown to include a sensor 2210 (e.g., a foveated sensor, such as a VST sensor) associated with a user device 2290 (e.g., a computing device or a mobile device, such as an XR device); an ISP 2220; an eye, head, and motion tracking engine 2230; an eye gaze prediction engine 2240; an intraframe DRV control engine 2250; an ISP clock control engine 2260; a DDR clock control engine 2270; and a DDR memory 2280.

During operation of the system 2200 of FIG. 22, the sensor 2210 can receive image data including a plurality of frames 2215 of a scene for one active-frame duration. The image data (e.g., of the active-frame duration) can be divided into a plurality of windows (e.g., five windows). Each frame of the plurality of frames 2215 can have a respective region of a plurality of regions (e.g., three regions) including a fovea region, a middle region, and a peripheral region.

The sensor 2210 can transmit the frames 2215 to the ISP 2220 and to the eye, head, and motion tracking engine 2230. One or more processors (e.g., of the eye, head, and motion tracking engine 2230) can determine, based on motion tracking of a user associated with the one or more foveated sensors, an eye gaze location associated with the scene. The eye, head, and motion tracking engine 2230 can send, to the eye prediction engine 2240, the eye gaze location associated with the scene.

One or more processors (e.g., of the eye gaze prediction engine 2240) can determine, based on the eye gaze location associated with the scene, a location of the fovea region and a location of the middle region within the scene. The eye gaze prediction engine 2240 can send, to the sensor 2210 and to the intraframe DRV control engine 2250, the location of the fovea region and the location of the middle region 2225 within the scene. The sensor 2210 can adjust, based on the location of the fovea region and the location of the middle region 2225 within the scene, the regions for subsequent frames such that they are subsampled at the appropriate locations within the scene.

One or more processors (e.g., of an intraframe DRV control engine 2250) can determine, based on the location of the fovea region and the location of the middle region 2225 within the scene, a respective start time (and respective end time) and a respective processing scaling factor for each window of the plurality of windows. The one or more processors (e.g., of the intraframe DRV control engine 2250) can send, at the respective start time of each window of the plurality of windows based on the respective processing scaling factor determined for each window of the plurality of windows, a respective command (e.g., a vote) for adjusting a frequency and a bandwidth for processing the image data. In one or more examples, the respective command can be an ISP vote 2235 (e.g., a vote up or vote down) and/or a DDR vote 2245 (e.g., a vote up or vote down). In some examples, the intraframe DRV control engine 2250 can send the ISP vote 2235 to the ISP clock control engine 2260, and send the DDR vote 2245 to the DDR clock control engine 2270.

One or more processors (e.g., of the ISP clock control engine 2260) can modulate, based on the ISP vote 2235, a corresponding clock frequency (e.g., an ISP clock 2255) for a clock of the ISP 2220 to change a frequency of the ISP 2220 for processing the frames 2215.

One or more processors (e.g., of the DDR clock control engine 2270) can modulate, based on the DDR vote 2245, a corresponding clock frequency (e.g., a DDR clock 2265) for a clock of the DDR memory 2280 to change a bandwidth of the DDR memory 2280 for processing and storing the frames.

The one or more processors (e.g., of the ISP 2220) can process, based on the frequency of the ISP 2220 for processing, the frames 2215 to generate processed frames 2275. The ISP 2220 can send the processed frames 2275 to the DDR memory 2280. The one or more processors (e.g., of the DDR memory 2280) can, based on the bandwidth, process and store the processed frames 2275.

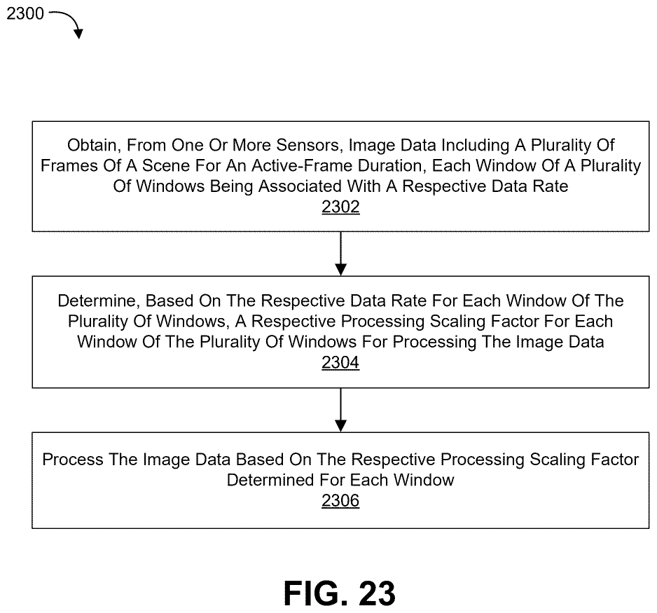

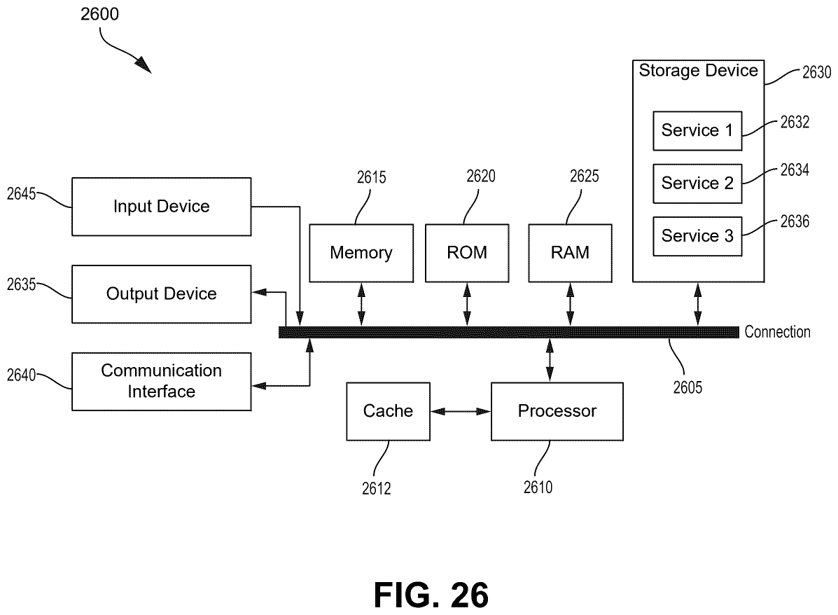

FIG. 23 is a flow chart illustrating an example of a process 2300 for gaze and exposure based dynamic resource voting. The process 2300 can be performed by a computing device (e.g., a computing device or computing system 2600 of FIG. 26) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 2300 may be implemented as software components that are executed and run on one or more processors (e.g., processor 2610 of FIG. 26, or other processor(s)). Further, the transmission and reception of signals by the computing device in the process 2300 may be enabled, for example, by one or more antennas and/or one or more transceivers (e.g., wireless transceiver(s)).

At block 2302, the computing device (or component thereof) can obtain (e.g., receive, retrieve, etc.), from one or more sensors, image data including a plurality of frames of a scene for an active-frame duration. In some cases, the image data can be divided into a plurality of windows (e.g., the windows 1010-1050 illustrated in FIG. 10, the windows 1410-1450 illustrated in FIG. 14, the windows 1910-1950 illustrated in FIG. 19, the windows 2110-2150 illustrated in FIG. 21, etc.). The image data of each window of the plurality of windows is associated with a respective data rate. Referring to FIG. 10 as an illustrative example, the window 3 1030 has a peak sensor data rate due to frames for all three of the different exposure times (exposure 1 (exp-1) 1015, exposure 2 (exp-2) 1025, or exposure 3 (exp-3) 1035) being transmitted together. The IFE clock frequency 1060 is thus set to a peak frequency (e.g., as denoted as F) and the DDR bandwidth 1070 is set to a peak bandwidth (e.g., as denoted as B). Referring to FIG. 19 as another illustrative example, the window 3 1930 has a peak sensor data rate due to frames corresponding to all three of the different regions (the periphery region 1815, the middle region 1825, and the fovea region 1835) being transmitted together. The IFE clock frequency 1860 for window 3 1830 is thus set to a peak frequency (e.g., as denoted as F) and the DDR bandwidth 1870 for window 3 1830 is set to a peak bandwidth (e.g., as denoted as B).

At block 2304, the computing device (or component thereof) can determine, based on the respective data rate of each window of the plurality of windows, a respective processing scaling factor for each window of the plurality of windows for processing the image data.

At block 2306, the computing device (or component thereof) can process the image data based on the respective processing scaling factor determined for each window.

In some aspects, each sensor of the one or more sensors is a high dynamic range (HDR) sensor (e.g., as described at least with respect to FIG. 6-FIG. 15), such as a staggered high dynamic range (SHDR) sensor as illustrated in FIG. 8 or other type of HDR sensor. In such aspects, each frame of the plurality of frames can be captured using a respective exposure time of a plurality of exposure times (e.g., exposure 1 (exp-1) 1015, exposure 2 (exp-2) 1025, or exposure 3 (exp-3) 1035 of FIG. 10).

In some cases, the computing device (or component thereof) can determine, based on the image data, the respective exposure time for each frame of the plurality of frames. In some aspects, the computing device (or component thereof) can determine, based on the respective exposure time determined for each frame of the plurality of frames, a respective exposure ratio (e.g., the exposure ratio 1525 of FIG. 15) for each exposure time of the plurality of exposure times. In some cases, the respective data rate of a window of the plurality of windows is dependent upon the respective exposure ratio determined for an exposure time of one or more frames associated with the window. For instance, as noted previously, the window 3 1030 of FIG. 10 has a higher sensor data rate than the windows 1010, 1020, 1040, and 1050 due to frames for all three of the different exposure times (exposure 1 (exp-1) 1015, exposure 2 (exp-2) 1025, or exposure 3 (exp-3) 1035) being transmitted together during the window 3 1030. In some examples, the computing device (or component thereof) can determine, based on the respective exposure ratio determined for each exposure time of the plurality of exposure times, a respective start time and the respective processing scaling factor determined for each window of the plurality of windows, such as described at least with respect to FIG. 13-FIG. 15).

In some aspects, the computing device (or component thereof) can send, at the respective start time of each window of the plurality of windows based on the respective processing scaling factor determined for each window of the plurality of windows, a respective command for adjusting a frequency and a bandwidth for processing the image data. In some cases, the respective command is a positive voting result or a negative voting result. For instance, as described at least with respect to FIG. 15, the respective command can be an ISP vote 1535 (e.g., a vote up or vote down) and/or a DDR vote 1545 (e.g., a vote up or vote down). In some cases, the intraframe DRV control engine 1550 can send the ISP vote 1535 to the ISP clock control engine 1560, and send the DDR vote 1545 to the DDR clock control engine 1570.

In some aspects, each sensor of the one or more sensors is a foveated sensor (e.g., as described at least with respect to FIG. 16-FIG. 22). In such aspects, each frame of the plurality of frames can have a respective region of a plurality of regions of the scene. For instance, the plurality of regions including a fovea region having a first resolution (e.g., the fovea region 1835 of FIG. 18), a middle region having a second resolution (e.g., the middle region 1825 of FIG. 18), and a peripheral region having a third resolution (e.g., the periphery region 1815 of FIG. 18), where the second resolution is lower than the first resolution and higher than the third resolution.

In some aspects, the computing device (or component thereof) can determine, based on motion tracking of a user associated with the one or more sensors, an eye gaze location associated with the scene. The computing device (or component thereof) can determine, based on the eye gaze location associated with the scene, a location of the fovea region and a location of the middle region within the scene. In some cases, the fovea region can be determined using other techniques in addition to or as an alternative to using eye gaze, such as based on detecting an object in a scene, detection motion, scene content, any combination thereof, and/or other factors.

In some aspects, the respective data rate of each window of the plurality of windows is dependent upon the respective region of each frame associated with the window (e.g., dependent upon a resolution of each respective region). For instance, as previously described, the window 3 1930 of FIG. 19 has a higher sensor data rate as compared to the windows 1910, 1920, 1940, and 1950 due to frames corresponding to all three of the different regions (the periphery region 1815, the middle region 1825, and the fovea region 1835) being transmitted together and based on the resolutions of the three regions.

In some aspects, the computing device (or component thereof) can determine, based on a location of the fovea region and a location of the middle region within the scene, a respective start time and the respective processing scaling factor for each window of the plurality of windows, such as described at least with respect to FIG. 20-FIG. 22.

In some aspects, the computing device (or component thereof) can send, at the respective start time of each window of the plurality of windows based on the respective processing scaling factor for each window of the plurality of windows, a respective command for adjusting a frequency and a bandwidth for processing the image data. In some cases, the respective command is a positive voting result or a negative voting result. For instance, as described at least with respect to FIG. 22, the respective command can be an ISP vote 2235 (e.g., a vote up or vote down) and/or a DDR vote 2245 (e.g., a vote up or vote down). In some examples, the intraframe DRV control engine 2250 can send the ISP vote 2235 to the ISP clock control engine 2260, and send the DDR vote 2245 to the DDR clock control engine 2270.

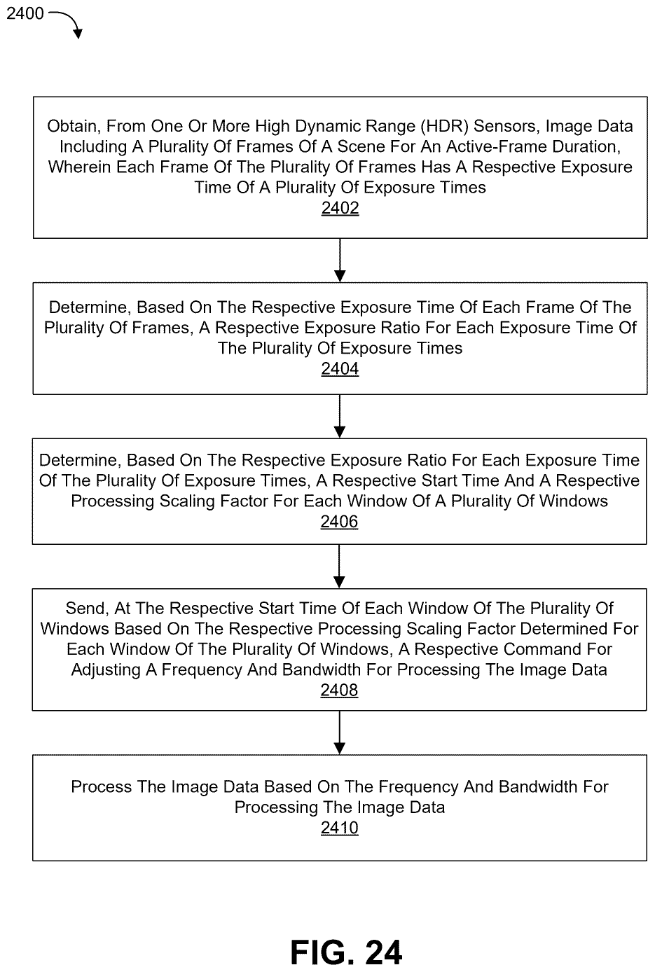

FIG. 24 is a flow chart illustrating an example of a process 2400 for exposure-based dynamic resource voting. The process 2400 can be performed by a computing device (e.g., a computing device or computing system 2600 of FIG. 26) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 2400 may be implemented as software components that are executed and run on one or more processors (e.g., processor 2610 of FIG. 26, or other processor(s)). Further, the transmission and reception of signals by the computing device in the process 2400 may be enabled, for example, by one or more antennas and/or one or more transceivers (e.g., wireless transceiver(s)).

At block 2402, the computing device (or component thereof) can receive (e.g., obtain, retrieve, etc.), from one or more high dynamic range (HDR) sensors (e.g., one or more staggered high dynamic range (SHDR) sensors as illustrated in FIG. 8 or other type of HDR sensor(s)), image data including a plurality of frames of a scene for an active-frame duration. Each frame of the plurality of frames has a respective exposure time of a plurality of exposure times (e.g., exposure 1 (exp-1) 1015, exposure 2 (exp-2) 1025, or exposure 3 (exp-3) 1035 of FIG. 10).

At block 2404, the computing device (or component thereof) can determine, based on the respective exposure time of each frame of the plurality of frames, a respective exposure ratio (e.g., the exposure ratio 1525 of FIG. 15) for each exposure time of the plurality of exposure times. In some cases, the image data can be divided into a plurality of windows (e.g., the windows 1010-1050 illustrated in FIG. 10, the windows 1410-1450 illustrated in FIG. 14, the windows 1910-1950 illustrated in FIG. 19, the windows 2110-2150 illustrated in FIG. 21, etc.). In some aspects, a respective data rate of a window of the plurality of windows is dependent upon the respective exposure ratio determined for an exposure time of one or more frames associated with the window. For instance, as noted previously, the window 3 1030 of FIG. 10 has a higher sensor data rate than the windows 1010, 1020, 104, and 1050 due to frames for all three of the different exposure times (exposure 1 (exp-1) 1015, exposure 2 (exp-2) 1025, or exposure 3 (exp-3) 1035) being transmitted together during the window 3 1030.

At block 2406, the computing device (or component thereof) can determine, based on the respective exposure ratio for each exposure time of the plurality of exposure times, a respective start time and a respective processing scaling factor for each window of the plurality of windows, such as described at least with respect to FIG. 15.

At block 2408, the computing device (or component thereof) can send, at the respective start time of each window of the plurality of windows based on the respective processing scaling factor determined for each window of the plurality of windows, a respective command for adjusting a frequency and a bandwidth for processing the image data. In some cases, the respective command is a positive voting result or a negative voting result. For instance, as described at least with respect to FIG. 15, the respective command can be an ISP vote 1535 (e.g., a vote up or vote down) and/or a DDR vote 1545 (e.g., a vote up or vote down). In some cases, the intraframe DRV control engine 1550 can send the ISP vote 1535 to the ISP clock control engine 1560, and send the DDR vote 1545 to the DDR clock control engine 1570.

At block 2410, the computing device (or component thereof) can process the image data based on the frequency and the bandwidth for processing the image data.

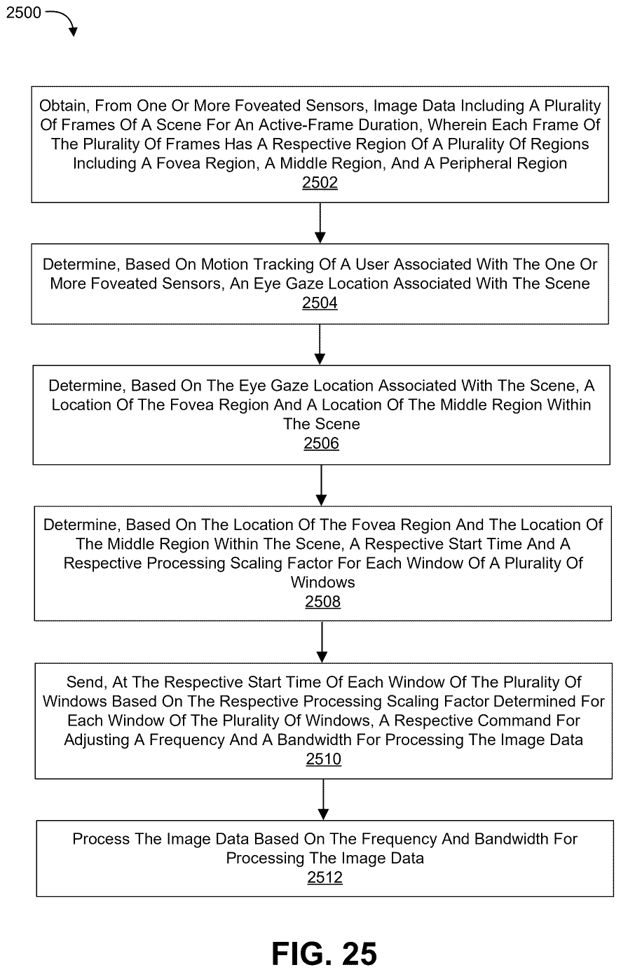

FIG. 25 is a flow chart illustrating an example of a process 2500 for gaze-based dynamic resource voting. The process 2500 can be performed by a computing device (e.g., a computing device or computing system 2600 of FIG. 26) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 2500 may be implemented as software components that are executed and run on one or more processors (e.g., processor 2610 of FIG. 26, or other processor(s)). Further, the transmission and reception of signals by the computing device in the process 2500 may be enabled, for example, by one or more antennas and/or one or more transceivers (e.g., wireless transceiver(s)).

At block 2502, the computing device (or component thereof) can receive (e.g., obtain, retrieve, etc.), from one or more foveated sensors, image data including a plurality of frames of a scene for an active-frame duration. Each frame of the plurality of frames has a respective region of a plurality of regions including a fovea region (e.g., the fovea region 1835 of FIG. 18), a middle region (e.g., the middle region 1825 of FIG. 18), and a peripheral region (e.g., the periphery region 1815 of FIG. 18). The fovea region has a first resolution, the middle region has a second resolution, and the peripheral region has a third resolution, where the second resolution is lower than the first resolution and higher than the third resolution.

At block 2504, the computing device (or component thereof) can determine, based on motion tracking of a user associated with the one or more foveated sensors, an eye gaze location associated with the scene. At block 2506, the computing device (or component thereof) can determine, based on the eye gaze location associated with the scene, a location of the fovea region and a location of the middle region within the scene. In some cases, the fovea region can be determined using other techniques in addition to or as an alternative to using eye gaze, such as based on detecting an object in a scene, detection motion, scene content, any combination thereof, and/or other factors.

At block 2508, the computing device (or component thereof) can determine, based on the location of the fovea region and the location of the middle region within the scene, a respective start time and a respective processing scaling factor for each window of a plurality of windows (e.g., the windows 1010-1050 illustrated in FIG. 10, the windows 1410-1450 illustrated in FIG. 14, the windows 1910-1950 illustrated in FIG. 19, the windows 2110-2150 illustrated in FIG. 21, etc.), such as described at least with respect to FIG. 20-FIG. 22. For instance, as described previously, the image data can be divided into the plurality of windows. In some aspects, a respective data rate of each window of the plurality of windows is dependent upon the respective region of each frame associated with the window (e.g., dependent upon a resolution of each respective region). For instance, as previously described, the window 3 1930 of FIG. 19 has a higher sensor data rate as compared to the windows 1910, 1920, 1940, and 1950 due to frames corresponding to all three of the different regions (the periphery region 1815, the middle region 1825, and the fovea region 1835) being transmitted together and based on the resolutions of the three regions.

At block 2510, the computing device (or component thereof) can send, at the respective start time of each window of the plurality of windows based on the respective processing scaling factor determined for each window of the plurality of windows, a respective command for adjusting a frequency and a bandwidth for processing the image data. In some cases, the respective command is a positive voting result or a negative voting result. For instance, as described at least with respect to FIG. 22, the respective command can be an ISP vote 2235 (e.g., a vote up or vote down) and/or a DDR vote 2245 (e.g., a vote up or vote down). In some examples, the intraframe DRV control engine 2250 can send the ISP vote 2235 to the ISP clock control engine 2260, and send the DDR vote 2245 to the DDR clock control engine 2270.

At block 2512, the computing device (or component thereof) can process the image data based on the frequency and the bandwidth for processing the image data

In some cases, the computing device of process 2300, process 2400, and process 2500 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 2300, process 2400, and process 2500 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 2300, process 2400, and process 2500 are each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 2300, process 2400, and process 2500 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 26 is a block diagram illustrating an example of a computing system 2600, which may be employed for gaze and exposure based dynamic resource voting. In particular, FIG. 26 illustrates an example of computing system 2600, which can be for example any computing device making up internal computing system, a remote computing system, a camera, or any component thereof in which the components of the system are in communication with each other using connection 2605. Connection 2605 can be a physical connection using a bus, or a direct connection into processor 2610, such as in a chipset architecture. Connection 2605 can also be a virtual connection, networked connection, or logical connection.

In some aspects, computing system 2600 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2600 includes at least one processing unit (CPU or processor) 2610 and connection 2605 that communicatively couples various system components including system memory 2615, such as read-only memory (ROM) 2620 and random access memory (RAM) 2625 to processor 2610. Computing system 2600 can include a cache 2612 of high-speed memory connected directly with, in close proximity to, or integrated as part of processor 2610.

Processor 2610 can include any general purpose processor and a hardware service or software service, such as services 2632, 2634, and 2636 stored in storage device 2630, configured to control processor 2610 as well as a special-purpose processor where software instructions are incorporated into the actual processor design. Processor 2610 may essentially be a completely self-contained computing system, containing multiple cores or processors, a bus, memory controller, cache, etc. A multi-core processor may be symmetric or asymmetric.

To enable user interaction, computing system 2600 includes an input device 2645, which can represent any number of input mechanisms, such as a microphone for speech, a touch-sensitive screen for gesture or graphical input, keyboard, mouse, motion input, speech, etc. Computing system 2600 can also include output device 2635, which can be one or more of a number of output mechanisms. In some instances, multimodal systems can enable a user to provide multiple types of input/output to communicate with computing system 2600.

Computing system 2600 can include communications interface 2640, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 2640 may also include one or more range sensors (e.g., LiDAR sensors, laser range finders, RF radars, ultrasonic sensors, and infrared (IR) sensors) configured to collect data and provide measurements to processor 2610, whereby processor 2610 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 2640 may also include one or more Global Navigation Satellite System (GNSS) receivers or transceivers that are used to determine a location of the computing system 2600 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2630 can include software services, servers, services, etc., that when the code that defines such software is executed by the processor 2610, it causes the system to perform a function. In some aspects, a hardware service that performs a particular function can include the software component stored in a computer-readable medium in connection with the necessary hardware components, such as processor 2610, connection 2605, output device 2635, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for image processing, the apparatus comprising: at least one memory; and at least one processor coupled to the at least one memory and configured to: obtain, from one or more sensors, image data comprising a plurality of frames of a scene for an active-frame duration, wherein the image data of each window of a plurality of windows (e.g., the image data can be divided in to the plurality of windows) being associated with a respective data rate; determine, based on the respective data rate of each window of the plurality of windows, a respective processing scaling factor for each window of the plurality of windows for processing the image data; and process the image data based on the respective processing scaling factor determined for each window.

Aspect 2. The apparatus of Aspect 1, wherein each sensor of the one or more sensors is a high dynamic range (HDR) sensor.

Aspect 3. The apparatus of Aspect 2, wherein the HDR sensor is a staggered high dynamic range (SHDR) sensor.

Aspect 4. The apparatus of any of Aspects 2 or 3, wherein each frame of the plurality of frames is captured using a respective exposure time of a plurality of exposure times.

Aspect 5. The apparatus of Aspect 4, further comprising determining, based on the image data, the respective exposure time for each frame of the plurality of frames.

Aspect 6. The apparatus of Aspect 5, further comprising determining, based on the respective exposure time determined for each frame of the plurality of frames, a respective exposure ratio for each exposure time of the plurality of exposure times.

Aspect 7. The apparatus of Aspect 6, wherein the respective data rate of a window of the plurality of windows is dependent upon the respective exposure ratio determined for an exposure time of one or more frames associated with the window.

Aspect 8. The apparatus of any of Aspects 6 or 7, further comprising determining, based on the respective exposure ratio determined for each exposure time of the plurality of exposure times, a respective start time and the respective processing scaling factor determined for each window of the plurality of windows.

Aspect 9. The apparatus of Aspect 8, further comprising sending, at the respective start time of each window of the plurality of windows based on the respective processing scaling factor determined for each window of the plurality of windows, a respective command for adjusting a frequency and a bandwidth for processing the image data.

Aspect 10. The apparatus of Aspect 9, wherein the respective command is a positive voting result or a negative voting result.

Aspect 11. The apparatus of any of Aspects 1 to 10, wherein each sensor of the one or more sensors is a foveated sensor.

Aspect 12. The apparatus of Aspect 11, wherein each frame of the plurality of frames has a respective region of a plurality of regions of the scene, the plurality of regions comprising a fovea region having a first resolution, a middle region having a second resolution, and a peripheral region having a third resolution, wherein the second resolution is lower than the first resolution and higher than the third resolution.

Aspect 13. The apparatus of Aspect 12, further comprising: determining, based on motion tracking of a user associated with the one or more sensors, an eye gaze location associated with the scene; and determining, based on the eye gaze location associated with the scene, a location of the fovea region and a location of the middle region within the scene.

Aspect 14. The apparatus of any of Aspects 12 or 13, wherein the respective data rate of each window of the plurality of windows is dependent upon at least one of the respective region of each frame associated with the window or a resolution of each respective region.

Aspect 15. The apparatus of any of Aspects 12 to 14, further comprising determining, based on a location of the fovea region and a location of the middle region within the scene, a respective start time and the respective processing scaling factor for each window of the plurality of windows.

Aspect 16. The apparatus of Aspect 15, further comprising sending, at the respective start time of each window of the plurality of windows based on the respective processing scaling factor for each window of the plurality of windows, a respective command for adjusting a frequency and a bandwidth for processing the image data.

Aspect 17. The apparatus of Aspect 16, wherein the respective command is a positive voting result or a negative voting result.

Aspect 18. An apparatus for image processing, the apparatus comprising: at least one memory; and at least one processor coupled to the at least one memory and configured to: obtain, from one or more high dynamic range (HDR) sensors, image data comprising a plurality of frames of a scene for an active-frame duration, wherein each frame of the plurality of frames has a respective exposure time of a plurality of exposure times; determine, based on the respective exposure time of each frame of the plurality of frames, a respective exposure ratio for each exposure time of the plurality of exposure times; determine, based on the respective exposure ratio for each exposure time of the plurality of exposure times, a respective start time and a respective processing scaling factor for each window of a plurality of windows (e.g., the image data can be divided in to the plurality of windows); send, at the respective start time of each window of the plurality of windows based on the respective processing scaling factor determined for each window of the plurality of windows, a respective command for adjusting a frequency and a bandwidth for processing the image data; and process the image data based on the frequency and the bandwidth for processing the image data.

Aspect 19. The apparatus of Aspect 18, wherein the one or more HDR sensors include one or more staggered high dynamic range (SHDR) sensors.

Aspect 20. An apparatus for image processing, the apparatus comprising: at least one memory; and at least one processor coupled to the at least one memory and configured to: obtain, from one or more foveated sensors, image data comprising a plurality of frames of a scene for an active-frame duration, wherein each frame of the plurality of frames has a respective region of a plurality of regions comprising a fovea region, a middle region, and a peripheral region; determine, based on motion tracking of a user associated with the one or more foveated sensors, an eye gaze location associated with the scene; determine, based on the eye gaze location associated with the scene, a location of the fovea region and a location of the middle region within the scene; determine, based on the location of the fovea region and the location of the middle region within the scene, a respective start time and a respective processing scaling factor for each window of a plurality of windows (e.g., the image data can be divided in to the plurality of windows); send, at the respective start time of each window of the plurality of windows based on the respective processing scaling factor determined for each window of the plurality of windows, a respective command for adjusting a frequency and a bandwidth for processing the image data; and process the image data based on the frequency and the bandwidth for processing the image data.

Aspect 21. A method for image processing, the method comprising: receiving, from one or more sensors, image data comprising a plurality of frames of a scene for an active-frame duration, wherein the image data of each window of a plurality of windows (e.g., the image data can be divided in to the plurality of windows) being associated with a respective data rate; determining, based on the respective data rate of each window of the plurality of windows, a respective processing scaling factor for each window of the plurality of windows for processing the image data; and processing the image data based on the respective processing scaling factor determined for each window.

Aspect 22. The method of Aspect 21, wherein each sensor of the one or more sensors is a high dynamic range (HDR) sensor.

Aspect 23. The method of Aspect 22, wherein the HDR sensor is a staggered high dynamic range (SHDR) sensor.

Aspect 24. The method of any of Aspects 22 or 23, wherein each frame of the plurality of frames is captured using a respective exposure time of a plurality of exposure times.

Aspect 25. The method of Aspect 24, further comprising determining, based on the image data, the respective exposure time for each frame of the plurality of frames.

Aspect 26. The method of Aspect 25, further comprising determining, based on the respective exposure time determined for each frame of the plurality of frames, a respective exposure ratio for each exposure time of the plurality of exposure times.

Aspect 27. The method of Aspect 26, wherein the respective data rate of a window of the plurality of windows is dependent upon the respective exposure ratio determined for an exposure time of one or more frames associated with the window.

Aspect 28. The method of any of Aspects 26 or 27, further comprising determining, based on the respective exposure ratio determined for each exposure time of the plurality of exposure times, a respective start time and the respective processing scaling factor determined for each window of the plurality of windows.

Aspect 29. The method of Aspect 28, further comprising sending, at the respective start time of each window of the plurality of windows based on the respective processing scaling factor determined for each window of the plurality of windows, a respective command for adjusting a frequency and a bandwidth for processing the image data.

Aspect 30. The method of Aspect 29, wherein the respective command is a positive voting result or a negative voting result.

Aspect 31. The method of any of Aspects 21 to 30, wherein each sensor of the one or more sensors is a foveated sensor.

Aspect 32. The method of Aspect 31, wherein each frame of the plurality of frames has a respective region of a plurality of regions of the scene, the plurality of regions comprising a fovea region having a first resolution, a middle region having a second resolution, and a peripheral region having a third resolution, wherein the second resolution is lower than the first resolution and higher than the third resolution.

Aspect 33. The method of Aspect 32, further comprising: determining, based on motion tracking of a user associated with the one or more sensors, an eye gaze location associated with the scene; and determining, based on the eye gaze location associated with the scene, a location of the fovea region and a location of the middle region within the scene.

Aspect 34. The method of any of Aspects 32 or 33, wherein the respective data rate of each window of the plurality of windows is dependent upon at least one of the respective region of each frame associated with the window or a resolution of each respective region.

Aspect 35. The method of any of Aspects 32 to 34, further comprising determining, based on a location of the fovea region and a location of the middle region within the scene, a respective start time and the respective processing scaling factor for each window of the plurality of windows.

Aspect 36. The method of Aspect 35, further comprising sending, at the respective start time of each window of the plurality of windows based on the respective processing scaling factor for each window of the plurality of windows, a respective command for adjusting a frequency and a bandwidth for processing the image data.

Aspect 37. The method of Aspect 36, wherein the respective command is a positive voting result or a negative voting result.

Aspect 38. A method for image processing, the method comprising: receiving, from one or more high dynamic range (HDR) sensors, image data comprising a plurality of frames of a scene for an active-frame duration, wherein each frame of the plurality of frames has a respective exposure time of a plurality of exposure times; determining, based on the respective exposure time of each frame of the plurality of frames, a respective exposure ratio for each exposure time of the plurality of exposure times; determining, based on the respective exposure ratio for each exposure time of the plurality of exposure times, a respective start time and a respective processing scaling factor for each window of a plurality of windows (e.g., the image data can be divided in to the plurality of windows); sending, at the respective start time of each window of the plurality of windows based on the respective processing scaling factor determined for each window of the plurality of windows, a respective command for adjusting a frequency and a bandwidth for processing the image data; and processing the image data based on the frequency and the bandwidth for processing the image data.

Aspect 39. The method of Aspect 38, wherein the one or more HDR sensors include one or more staggered high dynamic range (SHDR) sensors.

Aspect 40. A method for image processing, the method comprising: receiving, from one or more foveated sensors, image data comprising a plurality of frames of a scene for an active-frame duration, wherein each frame of the plurality of frames has a respective region of a plurality of regions comprising a fovea region, a middle region, and a peripheral region; determining, based on motion tracking of a user associated with the one or more foveated sensors, an eye gaze location associated with the scene; determining, based on the eye gaze location associated with the scene, a location of the fovea region and a location of the middle region within the scene; determining, based on the location of the fovea region and the location of the middle region within the scene, a respective start time and a respective processing scaling factor for each window of a plurality of windows (e.g., the image data can be divided in to the plurality of windows); sending, at the respective start time of each window of the plurality of windows based on the respective processing scaling factor determined for each window of the plurality of windows, a respective command for adjusting a frequency and a bandwidth for processing the image data; and processing the image data based on the frequency and the bandwidth for processing the image data.

Aspect 41. A non-transitory computer-readable medium having stored thereon instructions that, when executed by at least one processor, cause the at least one processor to perform operations according to any of Aspects 21 to 37.

Aspect 42. An apparatus for image processing, the apparatus including one or more means for performing operations according to any of Aspects 21 to 40.

Aspect 43. A non-transitory computer-readable medium having stored thereon instructions that, when executed by at least one processor, cause the at least one processor to perform operations according to any of Aspects 21 to 40.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for image processing, the apparatus comprising:
at least one memory; and
at least one processor coupled to the at least one memory and configured to:
obtain, from one or more sensors, image data comprising a plurality of frames of a scene for an active-frame duration, wherein the image data of each window of a plurality of windows being associated with a respective data rate;
determine, based on the respective data rate of each window of the plurality of windows, a respective processing scaling factor for each window of the plurality of windows for processing the image data; and
process the image data based on the respective processing scaling factor determined for each window.

2. The apparatus of claim 1, wherein each sensor of the one or more sensors is a high dynamic range (HDR) sensor.

3. The apparatus of claim 2, wherein the HDR sensor is a staggered high dynamic range (SHDR) sensor.

4. The apparatus of claim 2, wherein each frame of the plurality of frames is captured using a respective exposure time of a plurality of exposure times.

5. The apparatus of claim 4, further comprising determining, based on the image data, the respective exposure time for each frame of the plurality of frames.

6. The apparatus of claim 5, further comprising determining, based on the respective exposure time determined for each frame of the plurality of frames, a respective exposure ratio for each exposure time of the plurality of exposure times.

7. The apparatus of claim 6, wherein the respective data rate of a window of the plurality of windows is dependent upon the respective exposure ratio determined for an exposure time of one or more frames associated with the window.

8. The apparatus of claim 6, further comprising determining, based on the respective exposure ratio determined for each exposure time of the plurality of exposure times, a respective start time and the respective processing scaling factor determined for each window of the plurality of windows.

9. The apparatus of claim 8, further comprising sending, at the respective start time of each window of the plurality of windows based on the respective processing scaling factor determined for each window of the plurality of windows, a respective command for adjusting a frequency and a bandwidth for processing the image data.

10. The apparatus of claim 9, wherein the respective command is a positive voting result or a negative voting result.

11. The apparatus of claim 1, wherein each sensor of the one or more sensors is a foveated sensor.

12. The apparatus of claim 11, wherein each frame of the plurality of frames has a respective region of a plurality of regions of the scene, the plurality of regions comprising a fovea region having a first resolution, a middle region having a second resolution, and a peripheral region having a third resolution, wherein the second resolution is lower than the first resolution and higher than the third resolution.

13. The apparatus of claim 12, further comprising:
determining, based on motion tracking of a user associated with the one or more sensors, an eye gaze location associated with the scene; and
determining, based on the eye gaze location associated with the scene, a location of the fovea region and a location of the middle region within the scene.

14. The apparatus of claim 12, wherein the respective data rate of each window of the plurality of windows is dependent upon at least one of the respective region of each frame associated with the window or a resolution of each respective region.

15. The apparatus of claim 12, further comprising determining, based on a location of the fovea region and a location of the middle region within the scene, a respective start time and the respective processing scaling factor for each window of the plurality of windows.

16. The apparatus of claim 15, further comprising sending, at the respective start time of each window of the plurality of windows based on the respective processing scaling factor for each window of the plurality of windows, a respective command for adjusting a frequency and a bandwidth for processing the image data.

17. The apparatus of claim 16, wherein the respective command is a positive voting result or a negative voting result.

18. An apparatus for image processing, the apparatus comprising:
at least one memory; and
at least one processor coupled to the at least one memory and configured to:
obtain, from one or more high dynamic range (HDR) sensors, image data comprising a plurality of frames of a scene for an active-frame duration, wherein each frame of the plurality of frames has a respective exposure time of a plurality of exposure times;
determine, based on the respective exposure time of each frame of the plurality of frames, a respective exposure ratio for each exposure time of the plurality of exposure times;
determine, based on the respective exposure ratio for each exposure time of the plurality of exposure times, a respective start time and a respective processing scaling factor for each window of a plurality of windows;
send, at the respective start time of each window of the plurality of windows based on the respective processing scaling factor determined for each window of the plurality of windows, a respective command for adjusting a frequency and a bandwidth for processing the image data; and
processing the image data based on the frequency and the bandwidth for processing the image data.

19. The apparatus of claim 18, wherein the one or more HDR sensors include one or more staggered high dynamic range (SHDR) sensors.

20. An apparatus for image processing, the apparatus comprising:
at least one memory; and
at least one processor coupled to the at least one memory and configured to:
obtain, from one or more foveated sensors, image data comprising a plurality of frames of a scene for an active-frame duration, wherein each frame of the plurality of frames has a respective region of a plurality of regions comprising a fovea region, a middle region, and a peripheral region;
determine, based on motion tracking of a user associated with the one or more foveated sensors, an eye gaze location associated with the scene;
determine, based on the eye gaze location associated with the scene, a location of the fovea region and a location of the middle region within the scene;
determine, based on the location of the fovea region and the location of the middle region within the scene, a respective start time and a respective processing scaling factor for each window of a plurality of windows;
send, at the respective start time of each window of the plurality of windows based on the respective processing scaling factor determined for each window of the plurality of windows, a respective command for adjusting a frequency and a bandwidth for processing the image data; and
process the image data based on the frequency and the bandwidth for processing the image data.

21. A method for image processing, the method comprising:
receiving, from one or more sensors, image data comprising a plurality of frames of a scene for an active-frame duration, wherein the image data of each window of a plurality of windows being associated with a respective data rate;
determining, based on the respective data rate of each window of the plurality of windows, a respective processing scaling factor for each window of the plurality of windows for processing the image data; and
processing the image data based on the respective processing scaling factor determined for each window.

22. The method of claim 21, wherein each sensor of the one or more sensors is a high dynamic range (HDR) sensor, and wherein each frame of the plurality of frames is captured using a respective exposure time of a plurality of exposure times.

23. The method of claim 22, further comprising determining, based on the respective exposure time for each frame of the plurality of frames, a respective exposure ratio for each exposure time of the plurality of exposure times, wherein the respective data rate of a window of the plurality of windows is dependent upon the respective exposure ratio for an exposure time of one or more frames associated with the window.

24. The method of claim 23, further comprising determining, based on the respective exposure ratio for each exposure time of the plurality of exposure times, a respective start time and the respective processing scaling factor determined for each window of the plurality of windows.

25. The method of claim 24, further comprising sending, at the respective start time of each window of the plurality of windows based on the respective processing scaling factor determined for each window of the plurality of windows, a respective command for adjusting a frequency and a bandwidth for processing the image data.

26. The method of claim 21, wherein each sensor of the one or more sensors is a foveated sensor.

27. The method of claim 26, wherein each frame of the plurality of frames has a respective region of a plurality of regions of the scene, the plurality of regions comprising a fovea region having a first resolution, a middle region having a second resolution, and a peripheral region having a third resolution, wherein the second resolution is lower than the first resolution and higher than the third resolution.

28. The method of claim 27, wherein the respective data rate of each window of the plurality of windows is dependent upon at least one of the respective region of each frame associated with the window or a resolution of each respective region.

29. The method of claim 27, further comprising determining, based on a location of the fovea region and a location of the middle region within the scene, a respective start time and the respective processing scaling factor for each window of the plurality of windows.

30. The method of claim 29, further comprising sending, at the respective start time of each window of the plurality of windows based on the respective processing scaling factor for each window of the plurality of windows, a respective command for adjusting a frequency and a bandwidth for processing the image data.
